(19) United States
(12) Patent Application Publication
(10) Pub. No.: US 2023/0078552 A1
(43) Pub. Date: Mar. 16, 2023

(54) ELECTRONIC EQUIPMENT, DEVICE FOR VEHICLE, METHOD FOR ASSEMBLING ELECTRONIC EQUIPMENT, AND METHOD FOR ATTACHING DEVICE FOR VEHICLE

(71) Applicant: YOKOWO CO., LTD., Kita-ku, Tokyo (JP)

(72) Inventors: Tomio AMBE, Tomioka-shi, Gunma (JP); Ryota TAMAI, Tomioka-shi, Gunma (JP)

(73) Assignee: YOKOWO CO., LTD., Kita-ku, Tokyo (JP)

(21) Appl. No.: 17/798,560

(22) PCT Filed: Jul. 20, 2020
(86) PCT No.: PCT/JP2020/028016

§ 371 Date: Aug. 10, 2022

(30) Foreign Application Priority Data
Mar. 26, 2020 (JP) 2020-055355

(51) Int. Cl. H01Q 1/32; H01R 13/52; H01R 13/64; H01R 13/73; H01Q 1/50

(52) U.S. Cl. CPC H01Q 1/3275; H01Q 1/50; H01R 13/64; H01R 13/73; H01R 13/5213; H01R 2201/02; H01R 2201/26

(57) ABSTRACT

Electronic equipment, or the like, capable of achieving stable connection are provided. First electronic equipment 10 is electronic equipment of a device for vehicle 1. The first electronic equipment 10 includes a first connector 21 for electrically connecting second electronic equipment 50 of the device for vehicle, a first substrate 17 on which the first connector 21 is mounted, and a base 19. The first substrate 17 is fixed to the base 19 in a state where a positional relationship between the first substrate 17 or the first connector 21 and the base 19 varies according to a positional relationship between the first connector 21 and the first substrate 17.

### TECHNICAL FIELD

The present invention relates to electronic equipment, or the like.

### BACKGROUND ART

In related art, as in Patent Literature 1, an in-vehicle antenna device including an antenna unit and a signal processing unit has been proposed.

### CITATION LIST

### Patent Literature

Patent Literature 1: JP 6314277 B1

### SUMMARY OF INVENTION

### Technical Problem

However, stable connection is desired in assembly of inside of electronic equipment such as an antenna unit and connection between the antenna unit, a vehicle roof, and a signal processing unit.

It is therefore an object of the present invention to provide electronic equipment, or the like, capable of achieving stable connection.

### Solution to Problem

Electronic equipment according to the present invention is electronic equipment of a device for vehicle. The electronic equipment includes a connector for electrically connecting with another electronic equipment of the device for vehicle, a substrate on which the connector is mounted, and a chassis. The substrate is fixed to the chassis in a state where a positional relationship with the chassis varies according to a positional relationship between the connector and the substrate.

### Advantageous Effects of Invention

As described above, according to the present invention, electronic equipment, or the like, capable of achieving stable connection can be provided.

### BRIEF DESCRIPTION OF DRAWINGS

FIG. 1 is a side view of a device for vehicle according to the present embodiment.

FIG. 2 is a perspective view of a state in which a first substrate, a base, an attachment portion, and second electronic equipment are attached.

FIG. 3 is an exploded perspective view of the first substrate on which a first connector is mounted, the base, the attachment portion, a lid portion, a second substrate on which a second substrate is mounted, and a bottom portion.

FIG. 4 is an exploded perspective view of the first substrate on which the first connector is mounted and the base.

FIG. 5 is a cross-sectional configuration diagram of the first substrate, a first base, and a first fastening portion when the first connector is inserted into a first connector arranged region.

FIG. 6 is an exploded perspective view of the base to which the first connector and the first substrate are attached, the attachment portion, and the second electronic equipment.

FIG. 7 is an exploded perspective view of the attachment portion, the lid portion, and the second substrate on which a second connector is mounted.

FIG. 8 is a cross-sectional configuration diagram of the second substrate and the lid portion when the second connector is inserted into a second connector arranged region.

FIG. 9 is an exploded perspective view of the lid portion and the second substrate on which the second connector is mounted, as viewed from below.

FIG. 10 is a top view illustrating a positional relationship between the first substrate on which the first connector is mounted and the base, in a first state.

FIG. 11 is a top view illustrating a positional relationship between the first substrate on which the first connector is mounted and the base, in a second state.

FIG. 12 is a bottom view illustrating a positional relationship between the second substrate on which the second connector is mounted and the lid portion, in a third state.

FIG. 13 is a bottom view illustrating a positional relationship between the second substrate on which the second connector is mounted and the lid portion, in a fourth state.

FIG. 14 is a side view of the base to which the first connector and the first substrate are attached, the attachment portion, and the second electronic equipment as viewed from a y direction, in a state in which the second electronic equipment is brought closer to the attachment portion while a leg portion is located in a region including a first storage groove of the second electronic equipment.

FIG. 15 is a cross-sectional configuration view cut along a line A-A in FIG. 14.

FIG. 16 is a side view of the base to which the first connector and the first substrate are attached, the attachment portion, and the second electronic equipment as viewed from the y direction, in a state where the second electronic equipment is further brought closer to the attachment portion from the state of FIG. 14.

FIG. 17 is a cross-sectional configuration view cut along a line B-B in FIG. 16.

FIG. 18 is a side view of the base to which the first connector and the first substrate are attached, the attachment portion, and the second electronic equipment as viewed from the y direction, in a state where the second electronic equipment is further brought closer to the attachment portion from the state of FIG. 16.

FIG. 19 is a cross-sectional configuration view cut along a line C-C in FIG. 18.

FIG. 20 is a top view illustrating a positional relationship between the attachment portion to which the base to which the first connector and the first substrate are attached is attached and the second electronic equipment, in a fifth state.

FIG. 21 is a top view illustrating a positional relationship between the attachment portion to which the base to which the first connector and the first substrate are attached is attached and the second electronic equipment, in a sixth state.

### DESCRIPTION OF EMBODIMENTS

The present embodiment will be described below with reference to the drawings. Note that the embodiment is not limited to the following embodiments. In addition, content described in one embodiment is similarly applied to other embodiments in principle. Further, each embodiment and each modification can be appropriately combined.

### Configuration of Device for Vehicle 1

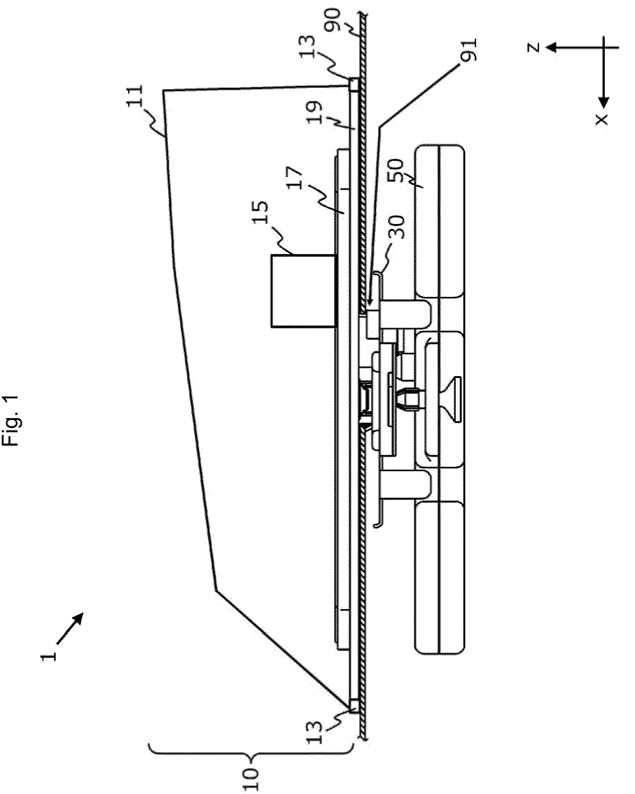

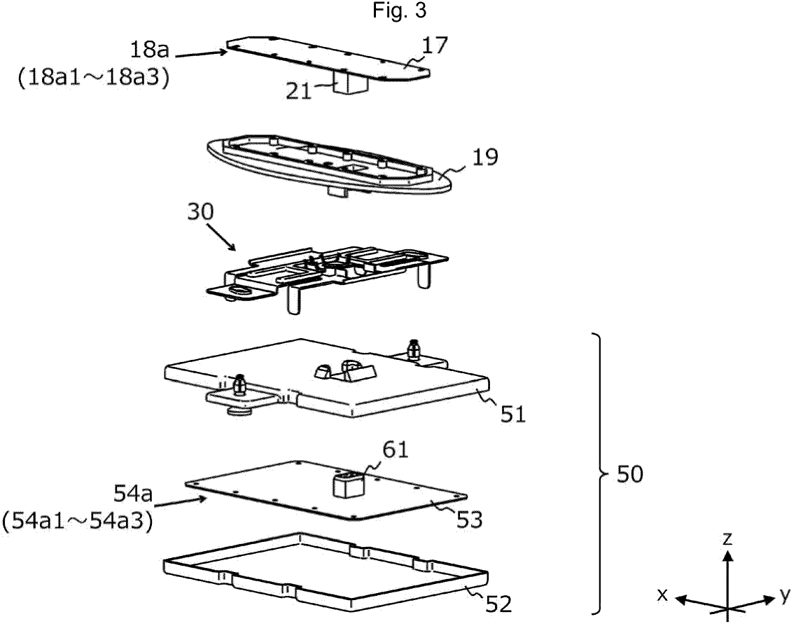

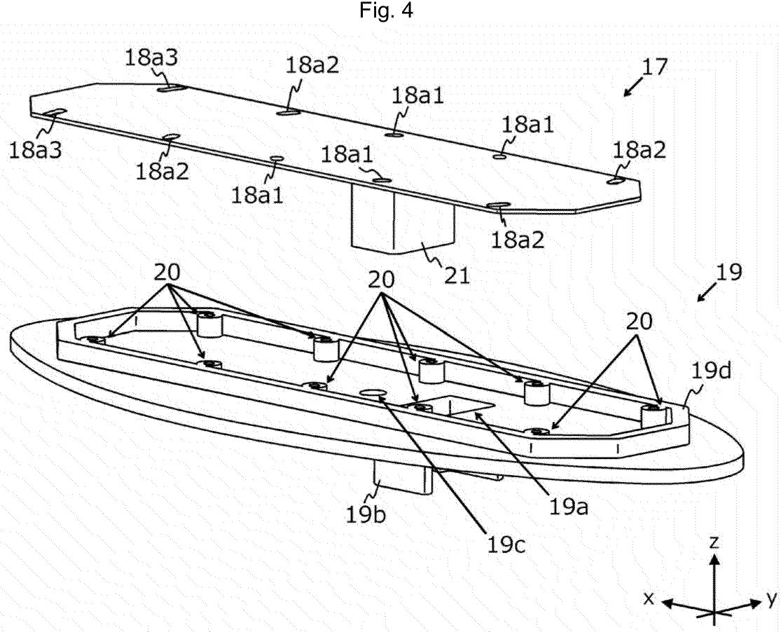

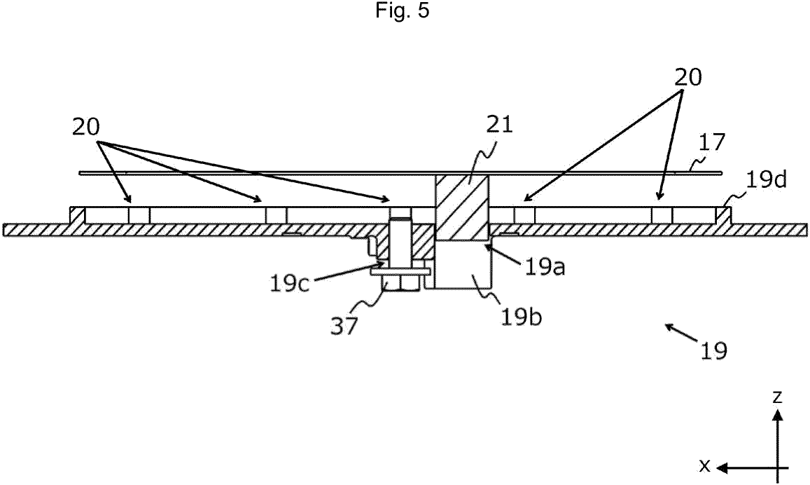

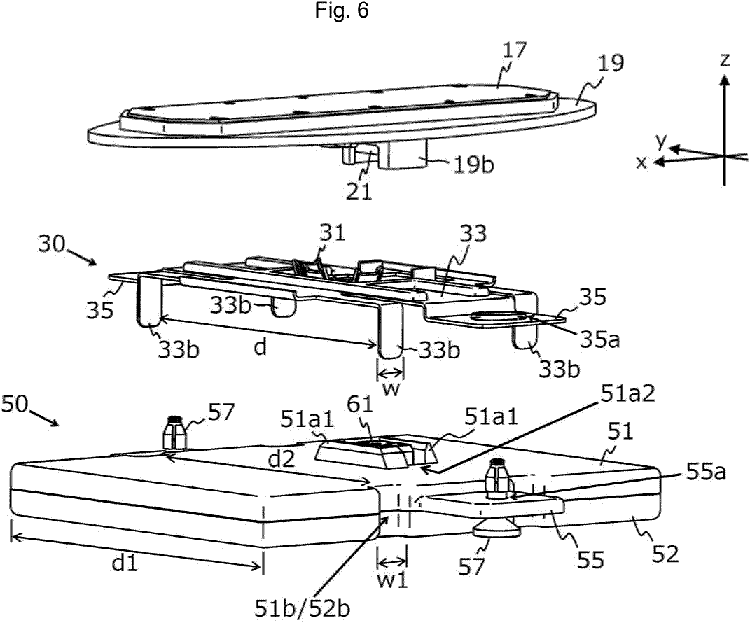

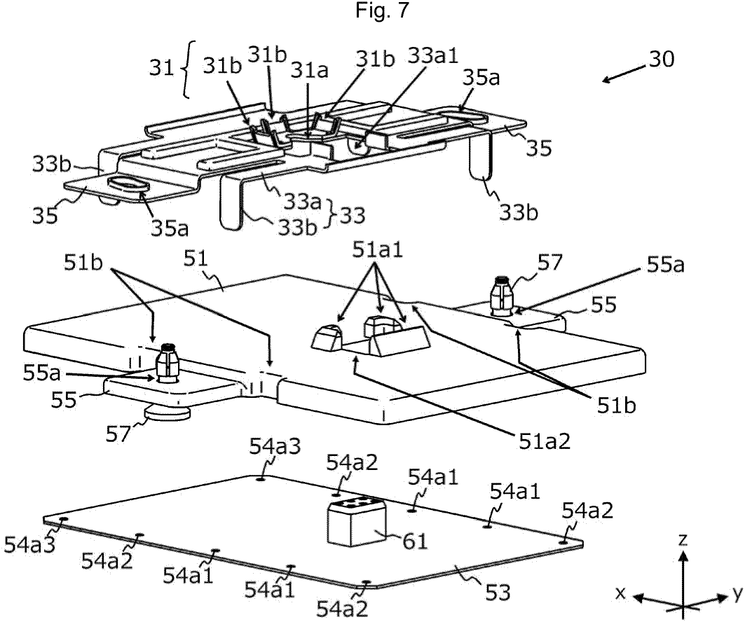

As illustrated in FIG. 1 to FIG. 3, a device for vehicle 1 of the present embodiment includes first electronic equipment (antenna unit) 10, an attachment portion 30, and second electronic equipment (signal processing unit) 50. The first electronic equipment 10 includes an antenna case 11, a pad 13, an antenna element 15, a first substrate 17, a base (first chassis) 19, a first connector 21 (illustrated in FIG. 4), and a first fastening portion (bolt) 37 (illustrated in FIG. 5). The attachment portion 30 includes a contact portion (claw washer) 31 (illustrated in FIG. 6), a body portion 33 (bracket), and a first arm portion 35. The second electronic equipment 50 includes a lid portion (second chassis) 51, a bottom portion 52, a second substrate 53 (illustrated in FIG. 7), a second arm portion 55, a second fastening portion 57, and a second connector 61.

The first electronic equipment 10 transmits a signal transmitted from the second electronic equipment 50 to outside. The first electronic equipment 10 receives a signal from outside and transmits the received signal to the second electronic equipment 50.

The attachment portion 30 is used to fix the first electronic equipment 10 in a positional relationship in which a vehicle roof 90 is sandwiched at an upper portion. Further, the attachment portion 30 is used to fix the second electronic equipment 50 at a lower portion.

The second electronic equipment 50 transmits a signal, which is transmitted from the first electronic equipment 10 to outside, to the first electronic equipment 10. The second electronic equipment 50 processes a signal received by the first electronic equipment 10. In addition, the second electronic equipment 50 transmits and receives signals to and from a gateway ECU (not illustrated) of the vehicle via a cable (not illustrated) of an in-vehicle local area network (LAN).

In order to describe a direction, a front-rear direction of the vehicle to which the device for vehicle 1 is attached will be described as an x direction, a left-right direction perpendicular to the x direction will be described as a y direction, and a substantially vertical direction perpendicular to the x direction and the y direction will be described as a z direction.

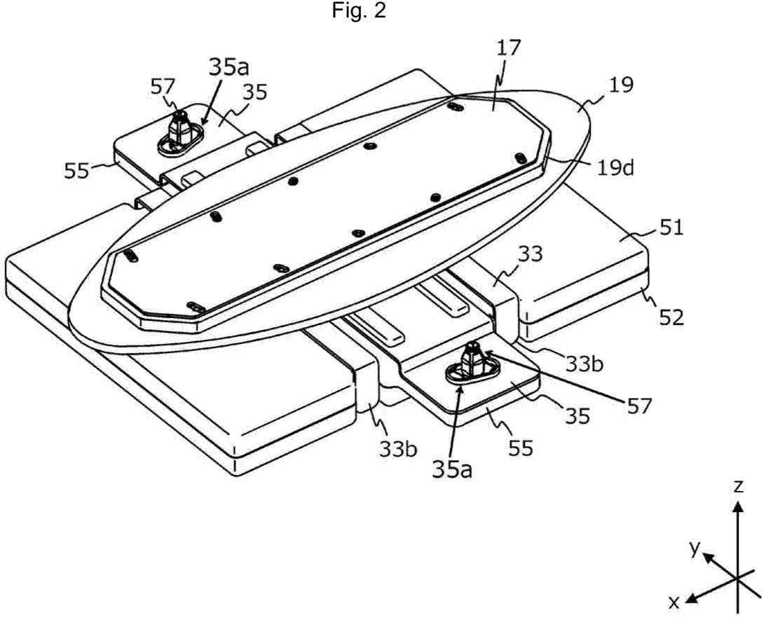

In FIG. 2, or the like, directions indicated by arrows of x, y and z axes are defined as a forward direction, a right direction, and an upward direction, respectively.

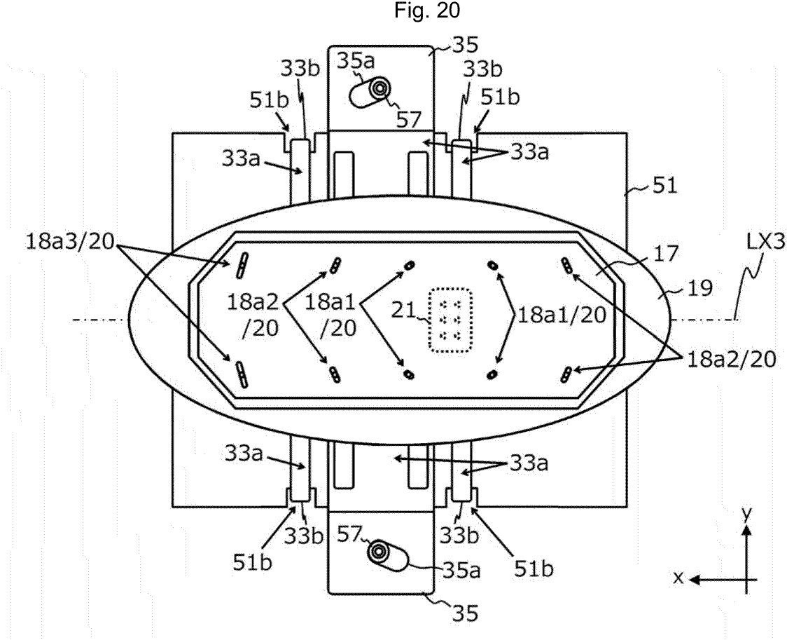

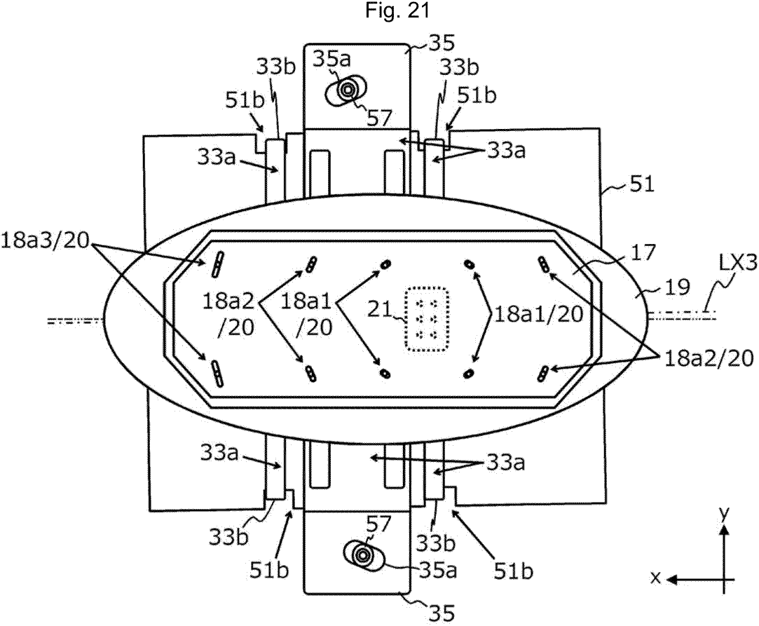

In FIG. 1, a member (the antenna element 15, the first substrate 17, or the like) that is accommodated in the antenna case 11 of the first electronic equipment 10 and cannot be seen from outside is also indicated by a solid line. Further, in FIG. 2 to FIG. 13, FIG. 20, and FIG. 21, illustration of the vehicle roof 90 is omitted. Still further, in FIG. 2 to FIG. 21, illustration of the antenna case 11, the pad 13, and the antenna element 15 is omitted. Yet further, in FIG. 5, an internal structure of the first connector is omitted.

### Configuration of First Electronic Equipment 10

Next, each unit of the first electronic equipment 10 will be described. The first electronic equipment 10 includes the antenna case 11, the pad 13, the antenna element 15, the first substrate 17, the base 19, a base-side attachment portion 20, and the first connector 21.

### Antenna Case 11

As illustrated in FIG. 1, the antenna case 11 is constituted with a synthetic resin having radio wave transparency. The antenna case 11 is inclined such that a front side in the x direction is lower than a rear side in the x direction. The antenna case 11 has an opening on a lower surface, and the base 19 is attached to the opening on the lower surface. The antenna element 15 and the first substrate 17 are accommodated in a space formed by the antenna case 11 and the base 19.

### Pad 13

The pad 13 is an elastic member formed with elastomer, rubber, or the like. A lower end peripheral portion of the antenna case 11 is attached to an upper portion of the pad 13. The pad 13 blocks a gap between the lower end peripheral portion of the antenna case 11 and a peripheral portion of the base 19.

### Antenna Element 15

The antenna element 15 transmits and receives electrical signals. Examples of the antenna element 15 can include a planar antenna for receiving satellite broadcasting, a planar antenna for receiving positional information (time information) from a satellite such as a GPS, an antenna including a capacitive loading element and a coil for receiving AM/FM broadcasting, an antenna for V2X (vehicle-to-vehicle communication, road-to-vehicle communication), an antenna for a communication terminal, or the like. The antenna element 15 is held by the base 19 via the first substrate 17, or the like. However, the antenna element 15 may be directly held by the base 19 without via the first substrate 17 or may be held on an inner wall of the antenna case 11. The antenna element 15 may be held by a holder attached to the base 19, or the like.

### First Substrate 17

Electronic components related to the antenna element 15 such as an amplifier circuit and a tuning circuit, the antenna element 15, or the like, are mounted on the first substrate 17. The first substrate 17 is held by the base 19. As illustrated in FIG. 4, the first connector 21 is mounted on a lower surface of the first substrate 17 by soldering, or the like, and the first substrate 17 and the first connector 21 are electrically connected to each other.

### Attachment Hole of First Substrate 17

The first substrate 17 is attached to the base 19 by screwing. The first substrate 17 includes a first substrate-side attachment portion 18a. The first substrate-side attachment portion 18a is used to be screwed with the base 19.

The first substrate-side attachment portion 18a is constituted as a long hole. A screw, or the like, to be used for being fixed to the base 19 passes through the long hole of the first substrate-side attachment portion 18a. The long hole of the first substrate-side attachment portion 18a has an arcuate long hole shape or a linear long hole shape. The arcuate long hole shape or the linear long hole shape of the long hole of the first substrate-side attachment portion 18a is along a circumference of a circle (or a side of a polygon) centered on a region of the first substrate 17 where the first connector 21 is to be attached when viewed from the z direction. The first substrate-side attachment portion 18a includes a plurality of long holes.

A size of each of the long holes of the first substrate-side attachment portions 18a is determined such that, among the long holes of the plurality of first substrate-side attachment portions 18a, a size of the long hole farther from a region where the first connector 21 is to be attached on the first substrate 17 is larger, and a size of the long hole closer to the region where the first connector 21 is to be attached on the first substrate 17 is smaller. In other words, the size of each of the long holes is determined such that a size of the long hole at a position farther from the region where the first connector 21 is to be attached on the first substrate 17 is larger than a size of the long hole at a position closer to the region. In the present embodiment, ten long holes are provided in the first substrate-side attachment portion 18a. Among the ten long holes of the first substrate-side attachment portion 18a, four holes closer to the region where the first connector 21 is to be attached on the first substrate 17 are defined as 11th long holes 18a1, four holes farther from the region than the 11th long holes 18a1 are defined as 12th long holes 18a2, and two holes farther from the region than the 12th long holes 18a2 are defined as 13th long holes 18a3.

Note that the first substrate-side attachment portion 18a may be constituted as a clearance hole including a region of said long hole. In addition, the first substrate-side attachment portion 18a may be constituted as a hole provided at a position away from the peripheral portion of the first substrate 17, but may be constituted as a notch including a region of said long hole and connected to the peripheral portion of the first substrate 17. In other words, a region (first substrate-side attachment portion 18a) to be used for screwing the first substrate 17 is constituted as a long hole, a clearance hole, or a notch.

### Base 19

The base 19 is, for example, an antenna base. The base 19 is covered with the antenna case 11 from above in the z direction to form an accommodation space for accommodating the antenna element 15, or the like. The first substrate 17 is attached to an upper portion of the base 19.

A first connector arranged region 19a is provided substantially at the center of the base 19. At least part of the first connector 21 penetrates the first connector arranged region 19a. The first connector arranged region 19a is constituted as a hole having substantially the same size as an outer shape of an xy cross-section of the first connector 21 so that the first connector 21 can be fitted. The first connector arranged region 19a is also used for positioning the first substrate 17 and the base 19.

On a lower surface of the base 19, a connector cover portion 19b is provided around the first connector arranged region 19a. The connector cover portion 19b protrudes downward in the z direction. The connector cover portion 19b covers at least part of a side portion of a portion protruding downward in the z direction from the first connector arranged region 19a in the first connector 21.

A base-side fastening portion hole 19c is provided in the vicinity of the first connector arranged region 19a of the base 19. As illustrated in FIG. 5, the first fastening portion (bolt) 37 is screwed into the base-side fastening portion hole 19c.

By the screwing of the first fastening portion 37 after the first electronic equipment 10 is temporarily fixed to the vehicle roof 90, a claw (a claw portion 31b) of the contact portion 31 of the attachment portion 30 comes into contact with the lower surface of the vehicle roof 90. As a result, electrical connection (grounding) between the first substrate 17 and the vehicle roof 90 is performed via the first substrate 17, the base 19, the contact portion 31, and the first fastening portion 37.

On the upper surface of the base 19, a wall portion 19d and the base-side attachment portion 20 are provided (see FIG. 4).

The wall portion 19d has a hollow substantially polygonal columnar shape. The wall portion 19d covers a side portion of the base-side attachment portion 20 of the base 19. The base-side attachment portion 20 is a round hole to be used for screwing the first substrate 17. The base-side attachment portion 20 is provided at a position facing the first substrate-side attachment portion 18a in the z direction. In other words, in the present embodiment, ten base-side attachment portions 20 are provided.

When viewed from the z direction, the long hole of the first substrate-side attachment portion 18a and the round hole of the base-side attachment portion 20 are formed such that the round hole of the base-side attachment portion 20 overlaps with a partial region of the long hole of the first substrate-side attachment portion 18a.

The base 19 may be constituted with a metal such as aluminum die casting, or part thereof may be constituted with a metal and the other part thereof may be constituted with a resin. The base 19 may be constituted with only a resin.

### First Connector 21

The first connector 21 is attached to a lower surface of the first substrate 17. The first connector 21 is used for electrical connection with the second substrate 53 of the second electronic equipment 50. A lower portion of the first connector 21 protrudes downward in the z direction. The lower portion of the first connector 21 penetrates the first connector arranged region 19a of the base 19 and an attachment portion-side connector arranged region 33a1 (see FIG. 6) of the body portion 33 of the attachment portion 30 and is fitted to the second connector 61 protruding upward in the z direction from the second substrate 53 of the second electronic equipment 50.

By connecting the first connector 21 and the second connector 61, it becomes in a state in which power supply from the second electronic equipment 50 to an electronic component provided on the first substrate 17, transmission of a signal from the antenna element 15 to the second electronic equipment 50, transmission of a signal from the second electronic equipment 50 to the antenna element 15, or the like, can be performed.

A temporary fixing claw (not illustrated) is provided on the base 19. The temporary fixing claw protrudes in a direction perpendicular to the z direction (x direction in the present embodiment). The temporary fixing claw is hooked to a vehicle attachment hole 91 of the vehicle roof 90. By this hooking, the temporary fixing claw sandwiches the vehicle roof 90 between a distal end portion of the temporary fixing claw and the base 19, and the first electronic equipment 10 is temporarily fixed to the vehicle roof 90.

### Configuration of Attachment Portion 30

Next, each unit of the attachment portion 30 will be described. The attachment portion 30 is interposed between the first electronic equipment 10 and the second electronic equipment 50. The attachment portion 30 includes the contact portion 31, the body portion 33, the first arm portion 35, and the first fastening portion 37.

### Contact Portion 31

As illustrated in FIG. 7, the contact portion 31 includes a first flat portion 31a and the claw portion 31b. The contact portion 31 is provided at a position closer to the vehicle roof 90 than the body portion 33.

The first flat portion 31a has a substantially quadrangular shape and has a surface perpendicular to the z direction. The first flat portion 31a is provided with a first hole through which the first fastening portion 37 passes.

The first hole of the first flat portion 31a has a gourd shape (a shape combining a large circle and a small circle) including a fastening hole and a detachment hole larger than said fastening hole. The detachment hole of the first hole of the first flat portion 31a has a size through which a head portion of the first fastening portion 37 passes. The fastening hole of the first hole of the first flat portion 31a has an inner diameter substantially equal to an outer diameter of the shaft portion of the first fastening portion 37. In the present embodiment, when viewed from above in the z direction, the detachment hole of the first hole of the first flat portion 31a is provided on a rear side in the x direction compared to the fastening hole of the first hole of the first flat portion 31a. However, the detachment hole and the fastening hole of the first hole of the first flat portion 31a may be arranged in another positional relationship.

The claw portion 31b extends upward in the z direction from an end portion of the first flat portion 31a. When the first electronic equipment 10 and the attachment portion 30 are connected in a positional relationship in which the vehicle roof 90 is sandwiched, some upper end portions of the claw portions 31b bite into a lower surface of the vehicle roof 90, and said some upper end portions come into contact with the vehicle roof 90. Among the claw portions 31b, two of them sandwiching the first flat portion 31a in the y direction come into contact with the vehicle roof 90. After the first electronic equipment 10 is temporarily fixed to the vehicle roof 90, the attachment portion 30 is brought closer to the vehicle roof 90 from below in the z direction such that the head portion of the first fastening portion 37 passes through the detachment holes of the first flat portion 31a and a second flat portion 33a. Thereafter, when the attachment portion 30 is moved in the horizontal direction (the rear side in the x direction), some of the claw portions 31b that do not come into contact with the vehicle roof 90 functions as a stopper of the attachment portion 30.

### Body Portion 33

The body portion 33 includes the second flat portion 33a and a leg portion 33b. The second flat portion 33a and the leg portion 33b of the body portion 33 have a U shape (groove shape) when viewed from the x direction.

The second flat portion 33a has a substantially quadrangular shape and has a surface perpendicular to the z direction. An upper surface of the second flat portion 33a is in contact with a lower surface of the first flat portion 31a. The second flat portion 33a is provided with a second hole (not illustrated) through which the first fastening portion 37 passes. The second flat portion 33a is provided with the attachment portion-side connector arranged region 33a1. The first connector 21 and a connector cover portion 19b pass through the attachment portion-side connector arranged region 33a1. The attachment portion-side connector arranged region 33a1 has a hole shape larger than the first connector arranged region 19a provided in the base 19. A size of the attachment portion-side connector arranged region 33a1 is determined such that a gap is formed in the x direction between the attachment portion-side connector arranged region 33a1 and the connector cover portion 19b. The xy cross-section of the attachment portion-side connector arranged region 33a1 is larger than the xy cross-section of an upper surface recess portion 51a2 which will be described later.

The second hole of the second flat portion 33a has the same shape and size as a shape and a size of the first hole of the first flat portion 31a.

When the attachment portion 30 is attached to the vehicle roof 90, the head portion of the first fastening portion 37 passes through the detachment hole of the first hole of the first flat portion 31a and the detachment hole of the second hole of the second flat portion 33a. Thereafter, the attachment portion 30 is moved in the horizontal direction such that the shaft portion of the first fastening portion 37 is located in a region including the fastening holes of the first flat portion 31a and the second flat portion 33a from a region including the detachment holes of the first flat portion 31a and the second flat portion 33a. After the movement, by fastening the first fastening portion 37, the first electronic equipment 10 and the attachment portion 30 are fixed to the vehicle roof 90 so as to sandwich the vehicle roof 90 in the z direction.

The contact portion 31 is attached to the body portion 33 such that the first hole of the first flat portion 31a and the second hole of the second flat portion 33a are in a positional relationship of overlapping in the z direction. The mode in which the second hole of the second flat portion 33a has the same shape and size as a shape and a size of the first hole of the first flat portion 31a has been described. However, the second hole of the second flat portion 33a may be constituted as a substantially quadrangular hole such that the first flat portion 31a of the contact portion 31 is fitted. In this case, the contact portion 31 is fitted into the second hole of the second flat portion 33a.

The leg portion 33b extends downward in the z direction from an end portion in the y direction of the second flat portion 33a. The leg portion 33b has a plane perpendicular to the y direction. At least a pair of the leg portions 33b is provided at both ends in the y direction of the second flat portion 33a so as to sandwich the second electronic equipment 50 in the y direction. However, a pair of the leg portions 33b may be provided at both ends of the second flat portion 33a in the x direction.

The leg portion 33b is used for positioning the attachment portion 30 and the second electronic equipment 50. The attachment portion 30 and the second electronic equipment 50 are positioned such that the leg portion 33b is positioned in a first storage groove 51b and a second storage groove 52b which will be described later.

### First Arm Portion 35

The first arm portion 35 has a plane perpendicular to the z direction. One of the first arm portions 35 extends so as to protrude leftward in the y direction from one of end portions of the second flat portion 33a in the y direction. The other of the first arm portions 35 extends so as to protrude rightward in the y direction from the other of the end portions of the second flat portion 33a in the y direction.

The first arm portions 35 are provided below compared to the second flat portion 33a in the z direction. In other words, the first arm portions 35 are provided at positions farther from the vehicle roof 90 than the second flat portion 33a. The first arm portion 35 is provided with a first arm portion-side attachment portion 35a. The second fastening portion 57 penetrates the first arm portion-side attachment portion 35a.

### First Arm Portion-Side Attachment Portion 35a

The second electronic equipment 50 is attached to the attachment portion 30 by clipping through the second fastening portion 57. The first arm portion-side attachment portion 35a of the first arm portion 35 of the attachment portion 30 is used for clipping with the second electronic equipment 50.

The first arm portion-side attachment portion 35a is constituted as a long hole through which the second fastening portion 57 passes. The long hole of the first arm portion-side attachment portion 35a has an arcuate long hole shape or a linear long hole shape. The arcuate long hole shape or the linear long hole shape of the long hole of the first arm portion-side attachment portion 35a is along a circumference of a circle (or a side of a polygon) centered on a region of the attachment portion 30 where the first connector 21 and the connector cover portion 19b are attached when viewed from the z direction.

Note that the first arm portion-side attachment portion 35a may be constituted as a clearance hole including a region of said long hole. In addition, the first arm portion-side attachment portion 35a may be constituted as a hole provided at a position away from the peripheral portion of the first substrate 17, but may be constituted as a notch including a region of said long hole and connected to the peripheral portion of the first substrate 17. In other words, the region (first arm portion-side attachment portion 35a) to be used for clipping the first arm portion 35 is constituted as a long hole, a clearance hole, or a notch.

### Configurations of Body Portion 33 and First Arm Portion 35

The body portion 33 and the first arm portion 35 are integrally constituted with a metal. For example, the body portion 33 and the first arm portion 35 are formed by bending or the like of a metal plate-like member. However, a portion of the second flat portion 33a of the body portion 33 in contact with the contact portion 31 may be constituted with a metal, and the other portion may be constituted with a non-metal such as a resin.

### Configurations of Contact Portion 31 and Body Portion 33

The contact portion 31 and the body portion 33 are separately constituted and are connected by screwing, or the like. However, the contact portion 31 and the body portion 33 may be integrally constituted with a metal.

### Non-Contact of Body Portion 33

It is desirable that dimensions, or the like, of the contact portion 31 and the body portion 33 are determined so that the body portion 33 is in a positional relationship of not being in contact with the vehicle roof 90. In this case, the body portion 33 covers part of the second electronic equipment 50 from above in the z direction in a positional relationship of not being in contact with the vehicle roof 90. As a result, it can be in a state in which there is no electrical connection between the attachment portion 30 and the vehicle roof 90 at a position other than the contact portion 31. In addition, a buffer material (not illustrated) including an insulating member may be provided between the body portion 33 and the vehicle roof 90 so that the body portion 33 does not temporarily come into contact with the vehicle roof 90 due to vibration of the vehicle or the like.

### First Fastening Portion 37

The first fastening portion 37 is constituted with a bolt. The first fastening portion 37 is used to be screwed with the base-side fastening portion hole 19c of the base 19. In the present embodiment, an example in which the first fastening portion 37 is a bolt will be described. By screwing the base 19 and the first fastening portion 37, the first electronic equipment 10 and the attachment portion 30 are connected in a positional relationship in which the vehicle roof 90 is sandwiched.

### Configuration of Second Electronic Equipment 50

Next, each unit of the second electronic equipment 50 will be described. The second electronic equipment 50 includes the lid portion 51, the bottom portion 52, the second substrate 53, a second substrate-side attachment portion 54a, the second arm portion 55, the second fastening portion 57, and the second connector 61.

### Lid Portion 51, Bottom Portion 52

The lid portion 51 has a substantially rectangular parallelepiped shape and has a lower surface opened. The bottom portion 52 has a substantially rectangular parallelepiped shape and has an upper surface opened. An upper portion of the bottom portion 52 is attached to a lower portion of the lid portion 51. The second substrate 53 and part of the second connector 61 are accommodated in a space formed by the lid portion 51 and the bottom portion 52.

On the upper surface of the lid portion 51, a connector guide portion 51a1 and the upper surface recess portion 51a2 are provided. The connector guide portion 51a1 protrudes upward in the z direction from the upper surface of the lid portion 51. The connector guide portion 51a1 is provided so as to surround a region above the upper surface recess portion 51a2 in the z direction. An inclined portion is provided at an end portion of the connector guide portion 51a1 on an upper side in the z direction, which is on a side of the upper surface recess portion 51a2 and another connector guide portion 51a1 facing in the x direction or the y direction.

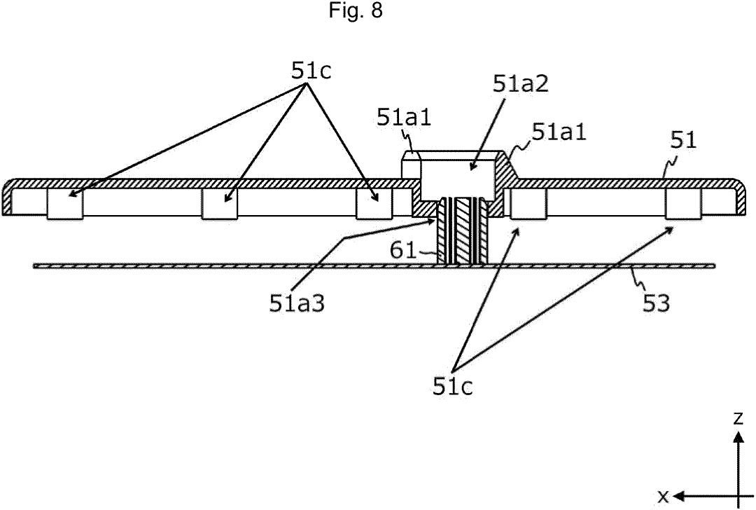

Said inclined portion has an inclined surface such that the upper side in the z direction is away from the second connector 61, and the lower side in the z direction approaches the second connector 61 (see FIG. 8).

In the present embodiment, two connector guide portions 51a1 are provided on a front side in the x direction and one connector guide portion 51a1 is provided on a rear side in the x direction. The connector guide portions 51a1 on the front side in the x direction have a substantially L shape when viewed from the z direction. One of the connector guide portions 51a1 on the front side in the x direction is in a positional relationship of facing in the y direction, to the other of the connector guide portions 51a1 on the front side in the x direction. The two connector guide portions 51a1 on the front side in the x direction face in the x direction, to the connector guide portion 51a1 on the rear side in the x direction.

The upper surface recess portion 51a2 is a recess protruding downward in the z direction from the upper surface of the lid portion 51. The upper surface recess portion 51a2 is provided at a position facing the attachment portion-side connector arranged region 33a1 in the z direction when the second electronic equipment 50 is attached to the attachment portion 30. The upper surface recess portion 51a2 accommodates the connector cover portion 19b of the base 19.

In addition, the upper surface recess portion 51a2 is provided with a second connector arranged region 51a3 through which at least part of the second connector 61 passes. The second connector arranged region 51a3 is provided at a position facing the first connector 21 in the z direction when the second electronic equipment 50 is attached to the attachment portion 30. The second connector arranged region 51a3 is constituted as a hole having substantially the same size as an outer shape of the xy cross-section of the second connector 61 so that the second connector 61 can be fitted. The second connector arranged region 51a3 is also used for positioning the second substrate 53 and the lid portion 51.

The xy cross-section of the upper surface recess portion 51a2 is larger than the xy cross-section of the second connector arranged region 51a3 and has such a size that allows the connector cover portion 19b to be fitted.

### First Storage Groove 51b, Second Storage Groove 52b

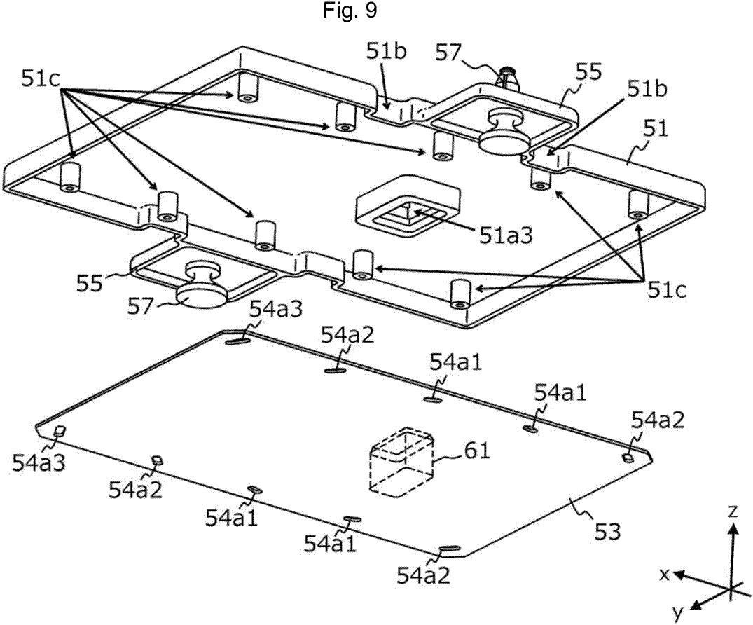

As illustrated in FIG. 9, the first storage groove 51b is provided on a side surface of the lid portion 51 perpendicular to the y direction. The first storage groove 51b extends in the z direction and is recessed in the y direction. The second storage groove 52b is provided on a side surface perpendicular to the y direction of the bottom portion 52 at a position connected to the first storage groove 51b. The second storage groove 52b extends in the z direction and is recessed in the y direction. The first storage groove 51b and the second storage groove 52b are used for positioning when the second electronic equipment 50 is attached to the attachment portion 30.

### Positional Relationship and Size of Leg Portion 33b, First Storage Groove 51b, and Second Storage Groove 52b

As an example of the positional relationship and the size of the leg portion 33b, or the like, a dimension of each portion is determined such that a distance d between the two leg portions 33b facing each other in the y direction is shorter than a width (first distance d1) in the y direction of a portion of the lid portion 51 and the bottom portion 52 where there is no storage groove and is longer than a distance (a width of the portion of the lid portion 51 and the bottom portion 52 having storage grooves in the y direction, a second distance d2) between the two first storage grooves 51b facing each other in the y direction (d2 < d < d1, see FIG. 6). The dimension of each portion is determined such that a width w in the x direction of the leg portion 33b is shorter than a width w1 in the x direction of the first storage groove 51b (w < w1). In the present embodiment, four leg portions 33b, four first storage grooves 51b, and four second storage grooves 52b are provided.

However, the positional relationship and the size of the leg portions 33b, or the like, are not limited to the above conditions. For example, the leg portion 33b may be constituted such that a length in the z direction is longer than a height in the z direction of the second electronic equipment 50 so as to be easily viewed from below in the z direction at the time of attachment.

A lid portion-side attachment portion 51c is provided on an inner wall of the lid portion 51. The lid portion-side attachment portion 51c is a round hole to be used for screwing the second substrate 53. The lid portion-side attachment portion 51c is provided at a position facing the second substrate-side attachment portion 54a which will be described later in the z direction. In the present embodiment, ten lid portion-side attachment portions 51c are provided.

### Second Substrate 53

The second substrate 53 is connected to the gateway ECU of the vehicle via a cable (not illustrated) of an in-vehicle LAN. The second substrate 53 mutually converts a digital signal and an analog signal. Specifically, the second substrate 53 transmits and receives a signal received by the antenna element 15 and a signal transmitted by the antenna element 15 to and from the gateway ECU as digital signals.

The gateway ECU transmits and receives signals to and from a device provided in the vehicle, such as an information processing device via the in-vehicle LAN. The information processing device is a device that outputs information by at least one of voice and video, such as a car navigation system and audio equipment.

The second substrate 53 includes, for example, an FM/AM tuner, a communication module, a position calculation module, a V2X module, an SXM/DAB module, or the like.

Electronic components related to the antenna element 15 such as FM/AM tuners are mounted on the second substrate 53. The second substrate 53 is held by the lid portion 51. The second connector 61 is mounted on an upper surface of the second substrate 53 by soldering, or the like, and the second substrate 53 and the second connector 61 are electrically connected to each other.

### Attachment Hole of Second Substrate 53

The second substrate 53 is attached to the lid portion 51 by screwing. The second substrate 53 includes the second substrate-side attachment portion 54a. The second substrate-side attachment portion 54a is used to be screwed with the lid portion 51.

The second substrate-side attachment portion 54a is constituted as a long hole. A screw, or the like, to be used for being fixed to the lid portion 51 passes through the long hole of the second substrate-side attachment portion 54a. The long hole of the second substrate-side attachment portion 54a has an arcuate long hole shape or a linear long hole shape. The arcuate long hole shape or the linear long hole shape of the long hole of the second substrate-side attachment portion 54a is along a circumference of a circle (or a side of a polygon) centered on a region of the second substrate 53 where the second connector 61 to be attached when viewed from the z direction. The second substrate-side attachment portion 54a includes a plurality of long holes.

A size of each of the long holes of the second substrate-side attachment portions 54a is determined such that, among the long holes of the plurality of second substrate-side attachment portions 54a, a size of the long hole farther from a region where the second connector 61 is to be attached on the second substrate 53 is larger, and a size of the long hole closer to the region where the second connector 61 is to be attached on the second substrate 53 is smaller. In other words, the size of each of the long holes is determined such that a size of the long hole at a position farther from the region where the second connector 61 is to be attached on the second substrate 53 is larger than a size of the long hole at a position closer to the region. In the present embodiment, ten long holes are provided in the second substrate-side attachment portion 54a. Among the ten long holes of the second substrate-side attachment portion 54a, four holes closer to the region where the second connector 61 is to be attached on the second substrate 53 are defined as 21st long holes 54a1, four holes farther from the region than the 21st long holes 54a1 are defined as 22nd long holes 54a2, and two holes farther from the region than the 22nd long holes 54a2 are defined as 23rd long holes 54a3.

Note that the second substrate-side attachment portion 54a may be constituted as a clearance hole including a region of said long hole. In addition, the second substrate-side attachment portion 54a may be constituted as a hole provided at a position away from the peripheral portion of the second substrate 53, but may be constituted as a notch including a region of said long hole and connected to the peripheral portion of the second substrate 53. In other words, a region (second substrate-side attachment portion 54a) to be used for screwing the second substrate 53 is constituted as a long hole, a clearance hole, or a notch.

When viewed from the z direction, the long hole of the second substrate-side attachment portion 54a and the round hole of the lid portion-side attachment portion 51c are formed such that the round hole of the lid portion-side attachment portion 51c overlaps with a partial region of the long hole of the second substrate-side attachment portion 54a.

### Second Arm Portion 55

The second arm portion 55 has a plane perpendicular to the z direction (see FIG. 7). One of the second arm portions 55 extends so as to protrude leftward in the y direction from one of side surfaces of the lid portion 51. The other of the second arm portions 55 extends so as to protrude rightward in the y direction from the other of the side surfaces of the lid portion 51.

The second arm portions 55 are provided below compared to the upper surface of the lid portion 51 in the z direction. In other words, the second arm portions 55 are provided at positions farther from the vehicle roof 90 than the upper surface of the lid portion 51. The second arm portion 55 is provided with a second arm portion-side attachment portion 55a. The second fastening portion 57 penetrates the second arm portion-side attachment portion 55a.

### Second Arm Portion-Side Attachment Portion 55a

The second arm portion-side attachment portion 55a is a round hole to be used for clipping the first arm portion 35 and the second arm portion 55 using the second fastening portion 57. The second arm portion-side attachment portion 55a is provided at a position facing the first arm portion-side attachment portion 35a in the z direction when the second electronic equipment 50 is attached to the attachment portion 30. Before the device for vehicle 1 is attached to the vehicle roof 90, the second fastening portion 57 is attached to the second arm portion 55.

### Second Fastening Portion 57

The second fastening portion 57 is constituted as a clip, or the like. The second fastening portion 57 penetrates the second arm portion-side attachment portion 55a and the first arm portion-side attachment portion 35a from below in the z direction. The second fastening portion 57 penetrates the second arm portion-side attachment portion 55a and the first arm portion-side attachment portion 35a, whereby the second electronic equipment 50 is fixed to the attachment portion 30.

When viewed from the z direction, the long hole of the first arm portion-side attachment portion 35a and the round hole of the second arm portion-side attachment portion 55a are formed such that the round hole of the second arm portion-side attachment portion 55a overlaps with a partial region of the long hole of the first arm portion-side attachment portion 35a.

### Configurations of Lid Portion 51 and Second Arm Portion 55

The lid portion 51 and the second arm portion 55 are integrally constituted with a resin. However, the lid portion 51 and the second arm portion 55 may be constituted with a material other than a resin, such as a metal.

### Assembly Procedure of First Electronic Equipment 10

Next, assembly procedure of the first electronic equipment 10 will be described. The antenna element 15, or the like, are mounted on an upper surface of the first substrate 17, and the first connector 21 is mounted on a lower surface of the first substrate 17. The first connector 21 is inserted into the first connector arranged region 19a, and the first substrate 17 is arranged on the base 19 (first insertion step, see FIG. 5).

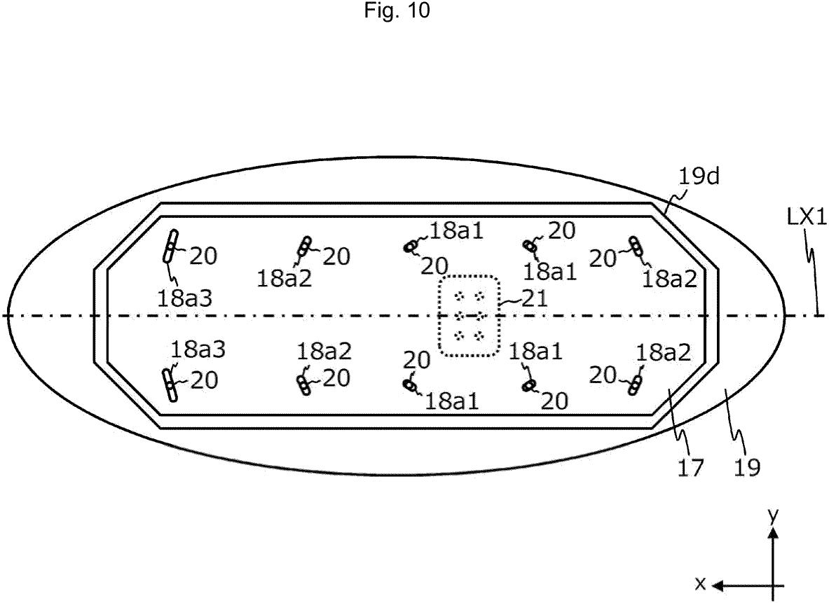

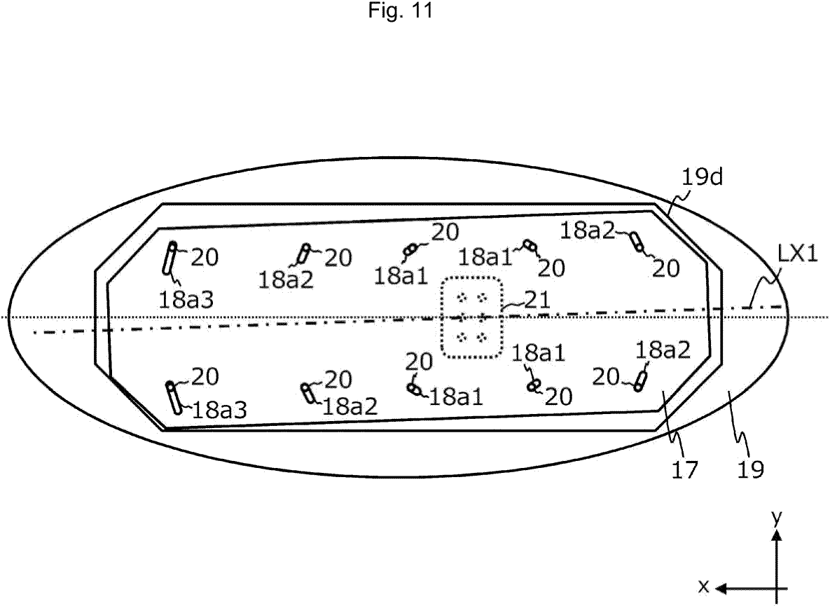

In a case where the first connector 21 is accurately attached to a predetermined position of the first substrate 17, a center line LX1 of the first substrate 17 in the y direction viewed from the z direction becomes in a positional relationship parallel to the x direction (first state, see FIG. 10). In a case where the first connector 21 is attached in a state of being displaced from the predetermined position of the first substrate 17 due to an attachment error, tolerance of each component, or the like, the center line LX1 of the first substrate 17 in the y direction viewed from the z direction becomes in a positional relationship not parallel to the x direction (second state, see FIG. 11).

In both the first state and the second state, the round hole of the base-side attachment portion 20 faces a partial region of the long hole of the first substrate-side attachment portion 18a in the z direction. Thus, screwing can be performed in a state where the screw and the round hole of the base-side attachment portion 20 sandwich the long hole of the first substrate-side attachment portion 18a. In other words, the first substrate 17 is fixed to the base 19 in a state where the positional relationship with the base 19 varies according to the positional relationship between the first connector 21 and the first substrate 17 defined by mounting (first fixing step).

Thus, the region of the base 19 to which the first substrate 17 is to be attached can vary, so that the region of the base 19 to which the first substrate 17 is to be attached is larger than the outer shape of the first substrate 17 viewed from the z direction.

In addition, screwing is performed in a state where stress such as twisting is not applied to the first substrate 17. Thus, stress to be applied to the first connector 21 can be reduced as compared with a form in which the first substrate 17 is screwed to the base 19 while the hole is forcedly positioned by stress being applied. The first connector 21 is fitted into the first connector arranged region 19a. Thus, even in a case where the first connector 21 is attached in a state of being displaced with respect to the first substrate 17, the first connector 21 can be attached to a predetermined position with respect to the base 19. Thus, stable connection can be maintained when the first electronic equipment 10 is assembled and after the assembly.

Thereafter, the first fastening portion 37 is attached to the lower surface of the base 19 by screwing (see FIG. 5). However, this stage is a stage before complete fastening is performed in a second step which will be described later. In other words, attachment of the first fastening portion 37 here is not complete fastening, but temporary attachment to such an extent that the first fastening portion 37 does not fall off the base 19. The antenna case 11 is attached to an upper portion of the base 19 via the pad 13.

### Assembly Procedure of Second Electronic Equipment 50

Next, assembly procedure of the second electronic equipment 50 will be described. The second connector 61 is mounted on the upper surface of the second substrate 53. The second connector 61 is inserted into the second connector arranged region 51a3, and the second substrate 53 is arranged under the lid portion 51 (second insertion step, see FIG. 8).

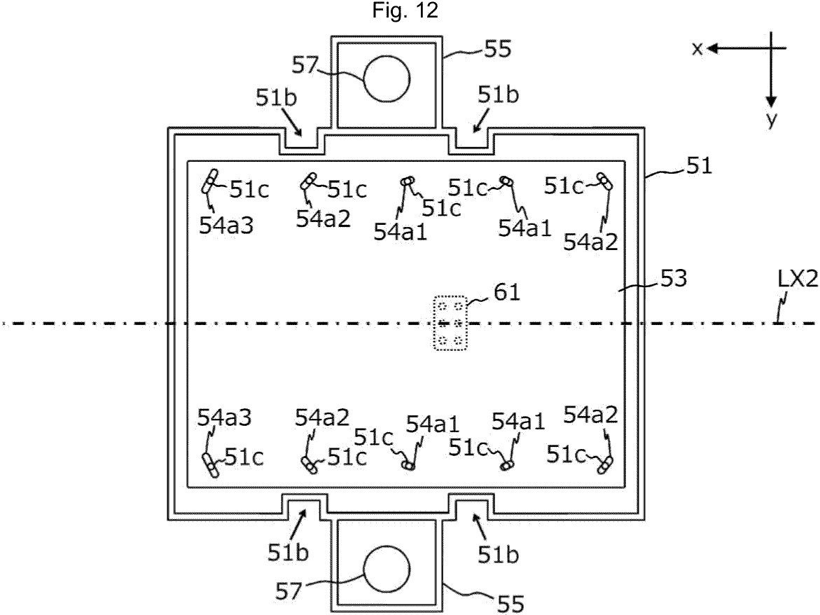

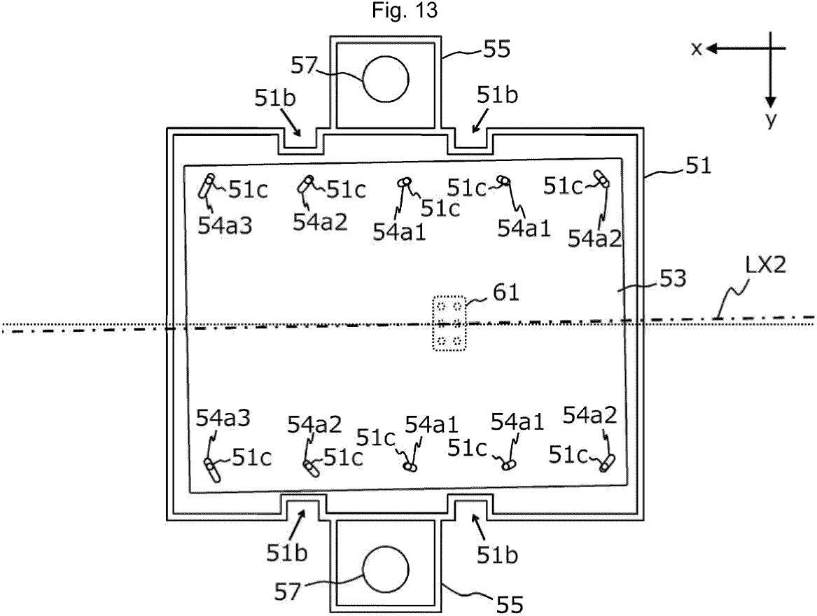

In a case where the second connector 61 is accurately attached to a predetermined position of the second substrate 53, a center line LX2 of the second substrate 53 in the y direction viewed from the z direction becomes in a positional relationship parallel to the x direction (third state, see FIG. 12). In a case where the second connector 61 is attached in a state of being displaced from the predetermined position of the second substrate 53 due to an attachment error, tolerance of each component, or the like, the center line LX2 of the second substrate 53 in the y direction viewed from the z direction becomes in a positional relationship not parallel to the x direction (fourth state, see FIG. 13).

In both the third state and the fourth state, the round hole of the lid portion-side attachment portion 51c faces a partial region of the long hole of the second substrate-side attachment portion 54a in the z direction. Thus, screwing can be performed in a state where the screw and the round hole of the lid portion-side attachment portion 51c sandwich the long hole of the second substrate-side attachment portion 54a. In other words, the second substrate 53 is fixed to the lid portion 51 in a state where the positional relationship with the lid portion 51 varies according to the positional relationship between the second connector 61 and the second substrate 53 defined by mounting (second fixing step).

Thus, the region of the lid portion 51 to which the second substrate 53 is to be attached can vary, so that the region of the lid portion 51 to which the second substrate 53 is to be attached is larger than an outer shape of the second substrate 53 viewed from the z direction.

In addition, screwing is performed in a state where stress such as twisting is not applied to the second substrate 53. Thus, stress to be applied to the second connector 61 can be reduced as compared with a form in which the second substrate 53 is screwed to the lid portion 51 while the hole is forcedly positioned by stress being applied. The second connector 61 is fitted into the second connector arranged region 51a3. Thus, even in a case where the second connector 61 is attached in a state of being displaced with respect to the second substrate 53, the second connector 61 can be attached to a predetermined position with respect to the lid portion 51. Thus, stable connection can be maintained when the second electronic equipment 50 is assembled and after the assembly.

Thereafter, the lid portion 51 and the bottom portion 52 are attached. The second fastening portion 57 is attached to the second arm portion 55.

### Attachment Procedure

Next, procedure for attaching the device for vehicle 1 to the vehicle roof 90 will be described.

The first electronic equipment 10 is assembled in advance. Further, the attachment portion 30 is assembled. Still further, the second electronic equipment 50 is assembled.

First, the first connector 21, the first fastening portion 37, or the like, of the first electronic equipment 10 are inserted into the vehicle attachment hole 91 of the vehicle roof 90 from above in the z direction. A temporary fixing claw is hooked to the peripheral portion of the vehicle attachment hole 91, and the first electronic equipment 10 is temporarily fixed to the vehicle roof 90 (first step).

Next, the attachment portion 30 is brought closer to an inner wall of the vehicle roof 90 such that the first connector 21 passes through the attachment portion-side connector arranged region 33a1 of the attachment portion 30 and the head portion of the first fastening portion 37 passes through the detachment holes of the first flat portion 31a and the second flat portion 33a. It becomes in a state in which the first connector 21 penetrates the attachment portion-side connector arranged region 33a1 of the body portion 33, and the first fastening portion 37 penetrates the detachable holes of the first flat portion 31a and the second flat portion 33a of the contact portion 31. Thereafter, the attachment portion 30 is slid backward in the x direction, and the shaft portion of the first fastening portion 37 is fitted into the fastening holes of the first flat portion 31a and the second flat portion 33a.

The inner diameters of the fastening holes of the first flat portion 31a and the second flat portion 33a are smaller than a horizontal width of the head portion of the first fastening portion 37. Thus, even before the screwing by the first fastening portion 37 is performed, the attachment portion 30 can be less likely to fall from the first electronic equipment 10. The connector cover portion 19b is provided on a side portion of the first connector 21. Thus, when the attachment portion 30 is moved backward in the x direction, it is possible to prevent the first connector 21 from coming into contact with the peripheral portion of the attachment portion-side connector arranged region 33a1.

Thereafter, the first fastening portion 37 is screwed into the base 19 of the first electronic equipment 10 (second step). As a result, the first electronic equipment 10 and the attachment portion 30 are fixed to the vehicle roof 90 in a positional relationship in which the first electronic equipment 10 and the attachment portion 30 sandwich at least part of the vehicle roof 90 in the z direction. Further, due to fastening of the first fastening portion 37, two claw portions 31b of the contact portion 31 sandwiching the first flat portion 31a in the y direction are connected to the vehicle roof 90.

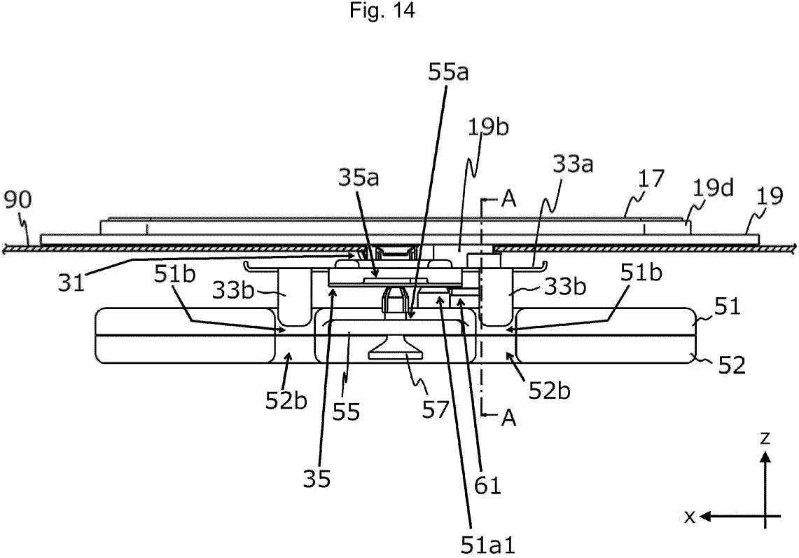

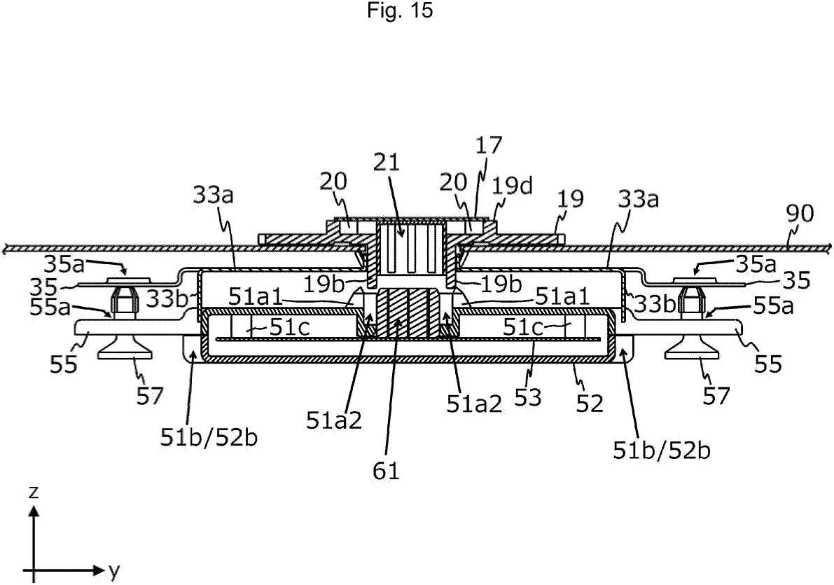

Next, the second electronic equipment 50 is attached to the attachment portion 30. The second electronic equipment 50 is brought closer to the attachment portion 30 such that each leg portion 33b of the attachment portion 30 is located in a region including the first storage groove 51b of the second electronic equipment 50 (see FIG. 14 and FIG. 15). The distance d between the two leg portions 33b facing each other in the y direction is shorter than the width (first distance d1) of the lid portion 51 and the bottom portion 52 in the y direction and longer than the distance (econd distance d2) between the two first storage grooves 51b facing each other in the y direction. The width w of the leg portion 33b in the x direction is shorter than the width w1 of the first storage groove 51b and the second storage groove 52b in the x direction. Thus, the leg portion 33b is merely located in the region including the first storage groove 51b and the second storage groove 52b and is not fixed.

At this time, an inclined portion of an upper end of the connector guide portion 51a1 approaches a lower end of the connector cover portion 19b in the z direction. In a case where the end portion of the connector cover portion 19b on the lower side in the z direction comes into contact with said inclined portion, the connector cover portion 19b is guided to be positioned between the two connector guide portions 51a1 arranged in the y direction by inclination of the inclined portion (see FIG. 15).

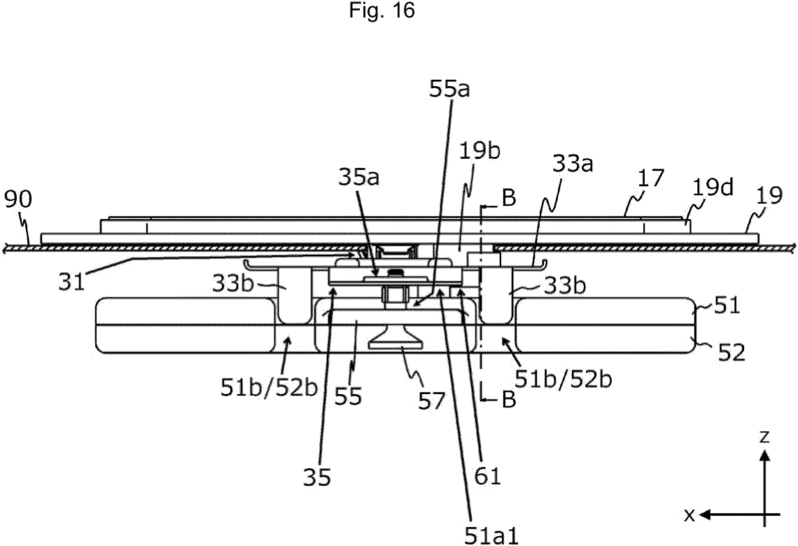

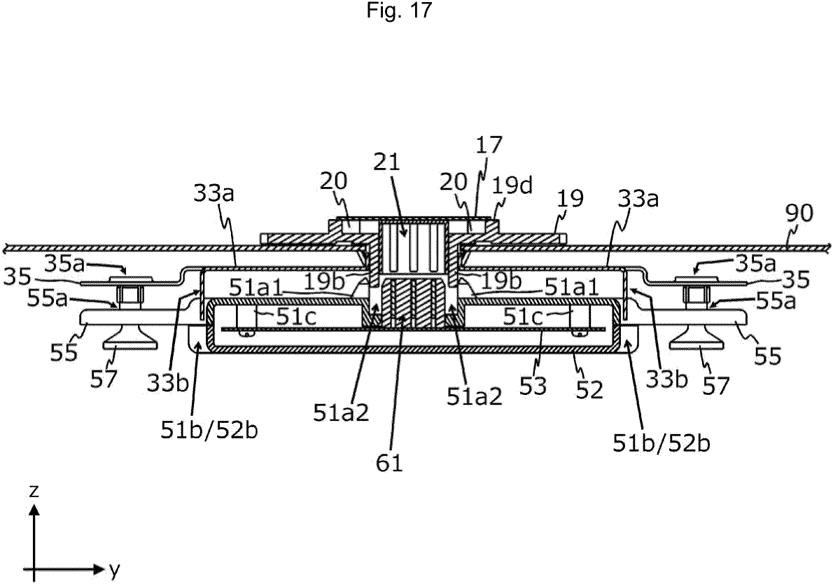

The second electronic equipment 50 is further brought closer to the attachment portion 30 such that each leg portion 33b of the attachment portion 30 is located in a region including the first storage groove 51b and the second storage groove 52b of second electronic equipment 50 (see FIG. 16 and FIG. 17). A side surface of the connector cover portion 19b is in contact with the two connector guide portions 51a1 arranged in the y direction and it becomes in a positional relationship in which an electrical contact of the first connector 21 and an electrical contact of the second connector 61 face each other in the z direction. The upper end portion of the second fastening portion 57 attached to the second arm portion 55 is brought closer to the first arm portion-side attachment portion 35a of the first arm portion 35.

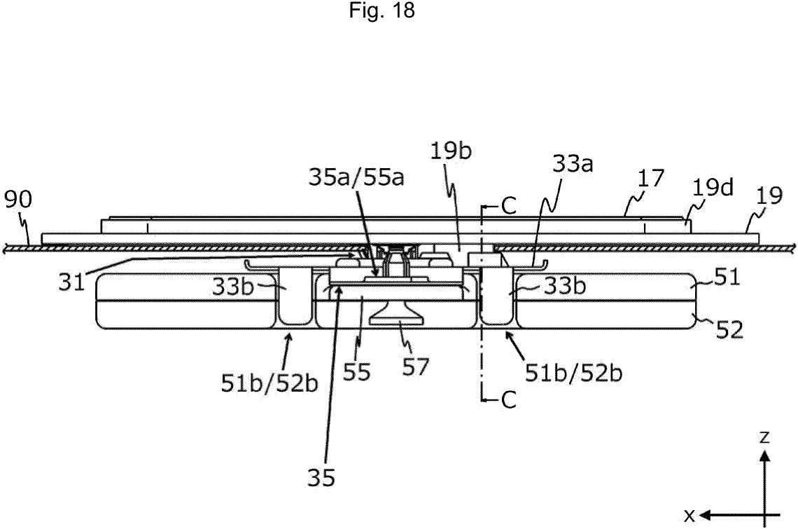

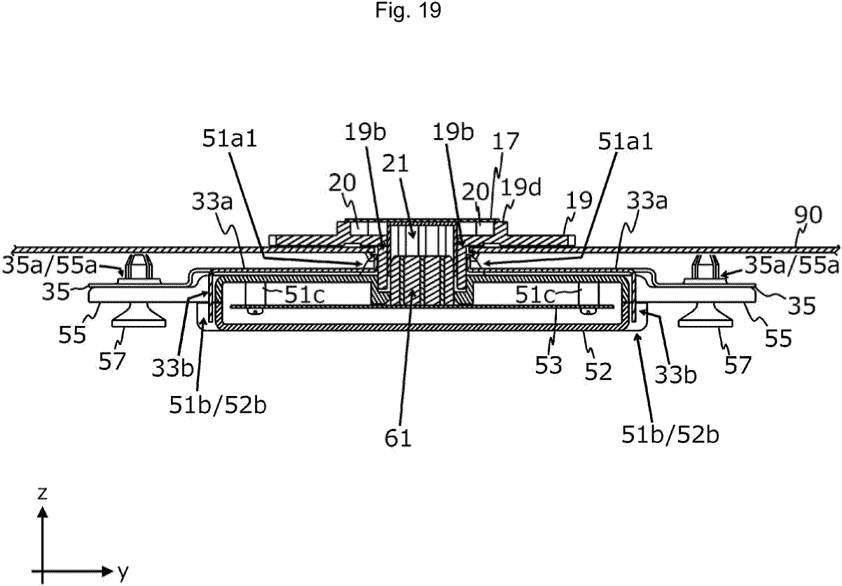

The second electronic equipment 50 is further brought closer to the attachment portion 30 such that each leg portion 33b of the attachment portion 30 is located in a region including the first storage groove 51b and the second storage groove 52b of the second electronic equipment 50 (third step, see FIG. 18 and FIG. 19). The lower end portion of the connector cover portion 19b is positioned in the vicinity of the upper surface recess portion 51a2 of the lid portion 51, and the electrical contact of the first connector 21 and the electrical contact of the second connector 61 come into contact with each other. The upper end portion of the second fastening portion 57 is inserted into the first arm portion-side attachment portion 35a and hooked.

In a case where the second electronic equipment 50 is attached to the attachment portion 30 without being displaced, a center line LX3 of the second electronic equipment 50 in the y direction as viewed from the z direction becomes in a positional relationship parallel to the x direction (fifth state, see FIG. 20). In a case where the second electronic equipment 50 is attached to the attachment portion 30 in a state of being displaced due to an attachment error, tolerance of each component, or the like, the center line LX3 of the second electronic equipment 50 in the y direction as viewed from the z direction becomes in a positional relationship not parallel to the x direction (sixth state, see FIG. 21).

In both the fifth state and the sixth state, the round hole of the second arm portion-side attachment portion 55a faces a partial region of the long hole of the first arm portion-side attachment portion 35a in the z direction. Thus, the first arm portion 35 and the second arm portion 55 can be clipped in a state where the second fastening portion 57 penetrates the first arm portion-side attachment portion 35a and the second arm portion-side attachment portion 55a. In other words, the second electronic equipment 50 is fixed to the attachment portion 30 in a state where the positional relationship between the attachment portion 30 and the second electronic equipment 50 varies according to the positional relationship between the first connector 21 and the attachment portion 30 and the positional relationship between the first connector 21 and the second electronic equipment 50.

In addition, clipping is performed in a state where stress such as twisting is not applied to the second electronic equipment 50. Thus, stress to be applied to the second connector 61 and the first connector 21 can be reduced as compared with a form in which the second electronic equipment 50 is clipped to the attachment portion 30 while the hole is forcedly positioned by stress being applied. Thus, stable connection can be maintained when the first electronic equipment 10 and the second electronic equipment 50 are attached and after the first electronic equipment 10 and the second electronic equipment 50 are attached.

The second electronic equipment 50 is fixed to the attachment portion 30 in a positional relationship in which the second electronic equipment 50 and the vehicle roof 90 sandwich at least part of the attachment portion 30 in the z direction. Attachment of the device for vehicle 1 to the vehicle roof 90 is completed.

### Effect of Long Hole of First Substrate-Side Attachment Portion 18a

A hole (first substrate-side attachment portion 18a) for screwing the first substrate 17 to the base 19 is constituted as a long hole. Thus, even in a case where the attachment positions, or the like, of the first substrate 17 and the first connector 21 are displaced, it is possible to align positions of the holes of the first substrate 17 and the base 19 without stress such as twisting being applied to the first connector 21. In addition, accuracy required when the first connector 21 is attached to the predetermined position of the first substrate 17 is reduced, so that assembly of the first electronic equipment 10 can be facilitated.

Note that the form is not limited to a form in which the long hole to be used for screwing the first substrate 17 and the base 19 is provided in the first substrate-side attachment portion 18a of the first substrate 17. Said long hole may be provided in at least one of the first substrate-side attachment portion 18a and the base-side attachment portion 20 of the base 19.

The hole or the notch of the first substrate-side attachment portion 18a is constituted to be larger as the hole or the notch is farther from the first connector 21. Thus, the hole or the notch of the first substrate-side attachment portion 18a closer to the first connector 21 can be made smaller. Thus, a substrate area of the first substrate 17 can be increased and a pattern can be easily drawn as compared with a form in which all of the holes or the notches of the first substrate-side attachment portion 18a are made larger.

### Effect of Long Hole of Second Substrate-Side Attachment Portion 54a

A hole (second substrate-side attachment portion 54a) for screwing the second substrate 53 to the lid portion 51 is constituted as a long hole. Thus, even in a case where the attachment positions, or the like, of the second substrate 53 and the second connector 61 are displaced, it is possible to align positions of the holes of the second substrate 53 and the lid portion 51 without stress such as twisting being applied to the second connector 61. In addition, accuracy required when the second connector 61 is attached to the predetermined position of the second substrate 53 is reduced, so that assembly of the second electronic equipment 50 can be facilitated.

Note that the form is not limited to a form in which the long hole to be used for screwing the lid portion 51 and the second substrate 53 is provided in the second substrate-side attachment portion 54a of the second substrate 53. Said long hole may be provided in at least one of the second substrate-side attachment portion 54a and the lid portion-side attachment portion 51c of the lid portion 51.

The hole or the notch of the second substrate-side attachment portion 54a is constituted to be larger as the hole or the notch is farther from the second connector 61. Thus, the hole or the notch of the second substrate-side attachment portion 54a closer to the second connector 61 can be made smaller. Thus, a substrate area of the second substrate 53 can be increased and a pattern can be easily drawn as compared with a form in which all of the holes or the notches of the second substrate-side attachment portion 54a are made larger.

### Effect of Fixing of First Electronic Equipment 10 and Second Electronic Equipment 50 Using Attachment Portion 30

The first electronic equipment 10 is fixed to the vehicle roof 90 at a preceding stage (first step and second step) and the second electronic equipment 50 is fixed to the attachment portion 30 at a subsequent stage (third step), by using the attachment portion 30 provided between the second electronic equipment 50 and the vehicle roof 90. Thus, the device for vehicle 1 including the first electronic equipment 10 and the second electronic equipment 50 can be easily attached to the vehicle.

In addition, when the first electronic equipment 10 and the second electronic equipment 50 are attached via the attachment portion 30, electrical connection (grounding) between the first electronic equipment 10 and the vehicle roof 90 and electrical connection between the first electronic equipment 10 and the second electronic equipment 50 can be performed simultaneously.

The contact portion 31 of the attachment portion 30 functions as a claw washer. Thus, in a case where the first electronic equipment 10 is used as an antenna unit, a device (excluding the long hole of the first substrate 17) having substantially the same configuration as a configuration of a normal antenna device that does not use the second electronic equipment (signal processing unit) 50 can be used as the first electronic equipment 10.

The first arm portion 35 provided in the leg portion 33b is brought into a state (flapped state) where a distal end portion of the first arm portion 35 is movable about a connection portion between the first arm portion 35 and the leg portion 33b by elastic deformation. It is therefore possible to reduce application of force to the first connector 21 and the second connector 61 when the second electronic equipment 50 moves due to vibration of the vehicle, or the like.

The first arm portions 35 are provided below compared to the second flat portion 33a in the z direction. It is therefore possible to provide a space in which the distal end portion of the second fastening portion 57 such as a clip protrudes between the first arm portion 35 and the vehicle roof 90.

### Effect of Long Hole of First Arm Portion-Side Attachment Portion 35a

A hole (first arm portion-side attachment portion 35a) for clipping the first arm portion 35 and the second arm portion 55 is constituted as a long hole. Thus, even in a case where the attachment positions, or the like, of the attachment portion 30 and the second electronic equipment 50 are displaced, it is possible to align positions of the holes of the attachment portion 30 and the second electronic equipment 50 without stress such as twisting being applied to the second electronic equipment 50.

Note that the form is not limited to a form in which the long hole to be used for clipping the first arm portion 35 and the second arm portion 55 is provided in the first arm portion-side attachment portion 35a of the first arm portion 35. Said long hole may be provided in at least one of the first arm portion-side attachment portion 35a and the second arm portion-side attachment portion 55a of the second arm portion 55.

### Effect of Providing Leg Portion 33b and First Storage Groove 51b

One or more pairs of the leg portions 33b are provided in a positional relationship in which the second electronic equipment 50 is sandwiched in the front-rear direction or the left-right direction. In the present embodiment, two pairs are provided. In addition, the second electronic equipment 50 is provided with storage grooves (first storage groove 51b, second storage groove 52b) in which the leg portions 33b are stored. Thus, when the second electronic equipment 50 is attached to the attachment portion 30 from below in the z direction, the leg portions 33b and said storage grooves function as a guide, which facilitates positioning, fitting of the first connector 21 and the second connector 61, or the like.

### Effects of Providing Connector Cover Portion 19b and Connector Guide Portion 51a1

A side surface of the first connector 21 is covered with the connector cover portion 19b, and a side surface of the second connector 61 is covered with the connector guide portion 51a1. Thus, it is possible to prevent the first connector 21 and the second connector 61 from colliding with other members and being damaged, for example, when the second electronic equipment 50 is attached to the attachment portion 30.

In addition, the leg portion 33b is guided by the first storage groove 51b and the second storage groove 52b, and the connector cover portion 19b is guided by the connector guide portion 51a1 and the upper surface recess portion 51a2. Thus, even in a case where the second electronic equipment 50 is attached to the attachment portion 30 from a position where at least some of the members are not visible (for example, a lower side of the second electronic equipment 50), the first connector 21 and the second connector 61 can be accurately connected.

### Application Example of Fixing of First Substrate 17 and Base 19

An example in which the first substrate 17 and the base 19 are fixed by screwing via the first substrate-side attachment portion 18a and the base-side attachment portion 20 has been described. However, fixing between the first substrate 17 and the base 19 is not limited to screwing via the long hole as long as the first substrate 17 is fixed to the base 19 in a state in which the positional relationship between the first substrate 17 and the base 19 defined by mounting can vary according to the positional relationship between the first connector 21 and the first substrate 17. For example, a mode is conceivable in which, after the first connector 21 is inserted into the first connector arranged region 19a of the base 19, part of the base 19 or the like, sandwiches the peripheral portion or the like of the first substrate 17 in the z direction, and the first substrate 17 is fixed to the base 19.

### Application Example of Fixing of Second Substrate 53 and Lid Portion 51

The example in which the second substrate 53 and the lid portion 51 are fixed by screwing via the second substrate-side attachment portion 54a and the lid portion-side attachment portion 51c has been described. However, fixing between the second substrate 53 and the lid portion 51 is not limited to screwing via the long hole as long as the second substrate 53 is fixed to the lid portion 51 in a state where the positional relationship between the second substrate 53 and the lid portion 51 can vary according to the positional relationship between the second connector 61 and the second substrate 53 defined by mounting. For example, a mode is conceivable in which, after the second connector 61 is inserted into the second connector arranged region 51a3 of the lid portion 51, part of the lid portion 51 or the like, sandwiches the peripheral portion or the like of the second substrate 53 in the z direction, and the second substrate 53 is fixed to the lid portion 51.

### Application Example to Devices Other Than Antenna Device

In the present embodiment, an example has been described in which the device for vehicle 1 is an antenna device for vehicle, the first electronic equipment 10 is an antenna unit, and the second electronic equipment 50 is a signal processing unit.

However, the device for vehicle 1 is not limited to these configurations. For example, it is conceivable that the first electronic equipment 10 is an imaging device such as a rear view camera, and the second electronic equipment 50 is a signal processing unit that performs image processing of data obtained by said imaging device. Alternatively, it is conceivable that the first electronic equipment 10 is a signal processing unit, and the second electronic equipment 50 is an antenna unit.

### Application Example of Arrangement of First Electronic Equipment 10

Furthermore, in the present embodiment, an example has been described in which the first electronic equipment 10 is disposed outside the vehicle, the second electronic equipment 50 is disposed inside the vehicle, the first electronic equipment 10 and the attachment portion 30 are attached in a positional relationship of sandwiching the vehicle roof 90, and then the second electronic equipment 50 is attached to the attachment portion 30.

However, the device for vehicle 1 is not limited to these configurations. For example, it is conceivable that the first electronic equipment 10 and the second electronic equipment 50 are disposed inside the vehicle, the first electronic equipment 10 and the attachment portion 30 are attached in a positional relationship of sandwiching a wall-shaped member (attachment object) of the vehicle, and then the second electronic equipment 50 is attached to the attachment portion 30.

### Connection Between First Arm Portion 35 and Second Arm Portion 55

Further, in the present embodiment, an example has been described in which the second fastening portion 57 is constituted as a clip, and the first arm portion 35 of the attachment portion 30 and the second arm portion 55 of the second electronic equipment 50 are connected by clipping. However, the first arm portion 35 of the attachment portion 30 and the second arm portion 55 of the second electronic equipment 50 may be connected by other means such as screwing.

### Modification of Connector Arranged Region

In the present embodiment, an example has been described in which the first connector arranged region 19a is a hole provided in the base 19, the attachment portion-side connector arranged region 33a1 is a hole provided in the attachment portion 30, and the second connector arranged region 51a3 is a hole provided in the lid portion 51. However, the first connector arranged region 19a is not limited to the hole and may be constituted as a notch provided at an edge, or the like, of the base 19. Further, the attachment portion-side connector arranged region 33a1 is not limited to the hole and may be constituted as a notch provided at an edge, or the like, of the attachment portion 30. In addition, the second connector arranged region 51a3 is not limited to the hole and may be constituted as a notch provided at an edge, or the like, of the lid portion 51.

In a case where the first connector arranged region 19a is constituted as a notch, the first connector 21 may pass through the first connector arranged region 19a by horizontal movement instead of insertion. In a case where the attachment portion-side connector arranged region 33a1 is constituted as a notch, the first connector 21 may pass through the attachment portion-side connector arranged region 33a1 by horizontal movement instead of insertion. In a case where the second connector arranged region 51a3 is constituted as a notch, the second connector 61 may pass through the second connector arranged region 51a3 by horizontal movement instead of insertion.

### Application Example of Means for Adjusting Deviation

In the present embodiment, the first connector 21 is fitted into the first connector arranged region 19a, whereby the positional relationship between the first substrate 17 fixed to the first connector 21 and the base 19 is determined. In other words, the positional relationship between the first substrate 17 and the base 19 varies according to displacement of the position where the first connector 21 is fixed to the first substrate 17. The insertion position of the screw can be adjusted by the long hole of the first substrate-side attachment portion 18a. Thus, even if the positional relationship between the first substrate 17 and the base 19 slightly varies due to said displacement, the first substrate 17 and the base 19 can be attached as long as part of the long hole of the first substrate-side attachment portion 18a and the round hole of the base-side attachment portion 20 overlap in the z direction. In other words, a mode in which the positional relationship between the first substrate 17 and the base 19 is determined on the basis of the position of the first connector 21 with respect to the base 19 has been described.

However, the positional relationship between the first connector 21 and the base 19 may be determined on the basis of the position of the first substrate 17 with respect to the base 19. In this case, the first substrate-side attachment portion 18a is constituted as a round hole instead of the long hole. The first connector arranged region 19a is constituted as a hole larger than an outer shape of the xy cross-section of the first connector 21.

The first substrate 17 is screwed to the base 19, whereby the positional relationship between the first connector arranged region 19a and the first connector 21 fixed to the first substrate 17 is determined. In other words, the positional relationship between the first connector 21 and the base 19 varies according to displacement of the position where the first connector 21 is fixed to the first substrate 17. The position where the first connector 21 is inserted can be adjusted by the first connector arranged region 19a including a hole larger than the outer shape of the xy cross-section of the first connector 21. Thus, even if the positional relationship between the first connector 21 and the base 19 slightly varies due to said displacement, the first substrate 17 and the base 19 can be attached as long as the first connector 21 can be accommodated in the first connector arranged region 19a.

In addition, the second connector 61 is fitted into the second connector arranged region 51a3, whereby the positional relationship between the second substrate 53 fixed to the second connector 61 and the lid portion 51 is determined. In other words, the positional relationship between the second substrate 53 and the lid portion 51 varies according to displacement of the position where the second connector 61 is fixed to the second substrate 53. The insertion position of the screw can be adjusted by the long hole of the second substrate-side attachment portion 54a. Thus, even if the positional relationship between the second substrate 53 and the lid portion 51 slightly varies due to said displacement, the second substrate 53 and the lid portion 51 can be attached as long as part of the long hole of the second substrate-side attachment portion 54a and the round hole of the lid portion-side attachment portion 51c overlap in the z direction. In other words, a mode in which the positional relationship between the second substrate 53 and the lid portion 51 is determined on the basis of the position of the second connector 61 with respect to the lid portion 51 has been described.

However, the positional relationship between the second connector 61 and the lid portion 51 may be determined on the basis of the position of the second substrate 53 with respect to the lid portion 51. In this case, the second substrate-side attachment portion 54a is constituted as a round hole instead of a long hole. The second connector arranged region 51a3 is constituted as a hole larger than the outer shape of the xy cross-section of the second connector 61.

The second substrate 53 is screwed to the lid portion 51, whereby the positional relationship between the second connector arranged region 51a3 and the second connector 61 fixed to the second substrate 53 is determined. In other words, the positional relationship between the second connector 61 and the lid portion 51 varies according to displacement of the position where the second connector 61 is fixed to the second substrate 53. The position where the second connector 61 is inserted can be adjusted by the second connector arranged region 51a3 including a hole larger than the outer shape of the xy cross-section of the second connector 61. Thus, even if the positional relationship between the second connector 61 and the lid portion 51 slightly varies due to said displacement, the second substrate 53 and the lid portion 51 can be attached as long as the second connector 61 can be accommodated in the second connector arranged region 51a3.

In the mode in which the positional relationship between the connector and the chassis is determined on the basis of the position of the substrate with respect to the chassis (the base 19 or the lid portion 51), there is a higher possibility that the positions of the first connector 21 and the second connector 61 are displaced as compared with the mode in which the positional relationship between the substrate and the chassis is determined on the basis of the position of the connector with respect to the chassis. However, in the present embodiment, the position of the first arm portion 35 to which the second fastening portion 57 is attached can be adjusted by the long hole of the first arm portion-side attachment portion 35a. Thus, even if the positional relationship between the attachment portion 30 and the second electronic equipment 50 slightly varies, as long as part of the long hole of the first arm portion-side attachment portion 35a and the second arm portion-side attachment portion 55a overlap in the z direction, the first connector 21 and the second connector 61 can be connected, and the first electronic equipment 10 and the second electronic equipment 50 can be attached to the vehicle roof 90.

Although some embodiments of the present invention have been described, these embodiments have been presented as examples and are not intended to limit the scope of the invention. These embodiments can be implemented in various other forms, and various omissions, substitutions, and changes can be made without departing from the gist of the invention. These embodiments and modifications thereof are included in the scope and gist of the invention and are included in the invention described in the claims and the equivalent scope thereof.

According to the present specification, the following aspects are provided.

### Aspect 1

Electronic equipment of a device for vehicle includes a connector for electrically connecting with another electronic equipment of the device for vehicle, a substrate on which the connector is mounted, and a chassis. The substrate is fixed to the chassis in a state in which a positional relationship between the substrate or the connector and the chassis varies according to a positional relationship between the connector and the substrate.

According to aspect 1, even in a case where attachment positions, or the like, of the substrate and the connector are displaced, it is possible to align fixing positions of the substrate and the chassis such as a base. In addition, accuracy required when the connector is attached to a predetermined position of the substrate is reduced, so that assembly of the electronic equipment can be facilitated.

For this reason, stable connection can be maintained when the electronic equipment is assembled and after the assembly.

### Aspect 2

Preferably, the substrate is fixed to the chassis by screwing. At least one of the substrate and the chassis is provided with a hole or a notch in a region to be used for the screwing.

According to aspect 2, even in a case where attachment positions, or the like, of the substrate and the connector are displaced, it is possible to align positions of holes of the substrate and the chassis such as a base. In addition, accuracy required when the connector is attached to a predetermined position of the substrate is reduced, so that assembly of the electronic equipment can be facilitated. For this reason, stable connection can be maintained when the electronic equipment is assembled and after the assembly.

### Aspect 3

More preferably, the hole is a long hole or a clearance hole.

According to aspect 3, even in a case where attachment positions of the substrate and the connector are displaced, the long hole or the clearance hole becomes wider region than a normal screw hole, so that it is possible to align positions of holes of the substrate and the chassis such as a base.

### Aspect 4

More preferably, the chassis has a connector arranged region through which part of the connector passes. A plurality of holes or notches provided in at least one of the substrate and the chassis and to be used for the screwing is provided such that the hole or the notch farther from at least one of the connector and a connector arranged region is larger than the hole or the notch closer from at least one of the connector and the connector arranged region.

According to aspect 4, a substrate area of the substrate can be increased and a pattern can be easily drawn as compared with a form in which all of the holes or the notches are made larger.

### Aspect 5

The device for vehicle includes first electronic equipment and second electronic equipment. The first electronic equipment includes a first connector, a first substrate on which the first connector is mounted, and a first chassis. The first substrate is fixed to the first chassis in a state where a positional relationship between the first substrate or the first connector and the first chassis varies according to a positional relationship between the first connector and the first substrate. The second electronic equipment includes a second connector, a second substrate on which the second connector is mounted, and a second chassis. The second substrate is fixed to the second chassis in a state where a positional relationship between the second substrate or the second connector and the second chassis varies according to a positional relationship between the second connector and the second substrate. The first electronic equipment and the second electronic equipment are electrically connected via the first connector and the second connector.

### Aspect 6

Preferably, the device for vehicle further includes an attachment portion. The first electronic equipment is attached to the vehicle in a positional relationship in which the first electronic equipment and the attachment portion sandwich at least part of a wall-shaped member of the vehicle. The second electronic equipment is attached to the attachment portion in a positional relationship in which the second electronic equipment and the wall-shaped member sandwich at least part of the attachment portion.

According to aspect 6, the first electronic equipment is fixed to the wall-shaped member of the vehicle at a preceding stage, and the second electronic equipment is fixed to the attachment portion at a subsequent stage, by using the attachment portion provided between the second electronic equipment and the wall-shaped member of the vehicle. Thus, the device for vehicle including the first electronic equipment and the second electronic equipment can be easily attached to the vehicle.

### Aspect 7

More preferably, the second electronic equipment is fixed to the attachment portion in a state where a positional relationship between the attachment portion and the second electronic equipment varies according to a positional relationship between the first connector and the attachment portion and a positional relationship between the first connector and the second electronic equipment.

According to aspect 7, even in a case where attachment positions, or the like, of the attachment portion and the second electronic equipment are displaced, it is possible to align fixing positions of the attachment portion and the second electronic equipment. Thus, stable connection can be maintained when the first electronic equipment and the second electronic equipment are attached and after the attachment.

### Aspect 8

More preferably, the wall-shaped member is a roof of the vehicle. The attachment portion includes a body portion that covers part of the second electronic equipment in a positional relationship of not being in contact with the roof, a contact portion that is provided at a position closer to the roof than the body portion and is in contact with the roof, and a first arm portion. The body portion includes a flat portion facing an upper surface of the second electronic equipment, and a leg portion extending downward from the flat portion and facing a side portion of the second electronic equipment. A second arm portion is provided on a side portion of the second electronic equipment. The second electronic equipment is attached to the attachment portion via a fastening portion that penetrates the first arm portion and the second arm portion from below, and at least one of the first arm portion and the second arm portion is provided with a hole or a notch in a region to be used for attaching the attachment portion and the second electronic equipment.

According to aspect 8, even in a case where attachment positions, or the like, of the attachment portion and the second electronic equipment are displaced, it is possible to align positions of holes of the attachment portion and the second electronic equipment. Thus, stable connection can be maintained when the electronic equipment is assembled and after the assembly.

### Aspect 9

The hole provided in at least one of the first arm portion and the second arm portion is a long hole or a clearance hole.

### Aspect 10

More preferably, the body portion includes a flat portion facing an upper surface of the second electronic equipment, and a leg portion extending downward from the flat portion and facing a storage groove provided in a side portion of the second electronic equipment. At least two as the leg portions are provided so as to sandwich a region including the storage groove of the second electronic equipment.

According to aspect 10, when the second electronic equipment is attached to the attachment portion, the leg portion and the storage groove function as guides, which facilitates positioning, fitting of the first connector and the second connector, or the like.

### Aspect 11

More preferably, a connector cover portion that covers a side surface of the first connector is provided in a region of the first chassis from which the first connector protrudes. A connector guide portion that covers at least part of a side surface of the second connector and a recess portion into which the connector cover portion is to be inserted are provided in a region of the second chassis from which the second connector protrudes. The second chassis has a connector arranged region through which part of the second connector passes. The connector arranged region is provided in the recess portion.

According to aspect 11, it is possible to prevent the first connector and the second connector from colliding with other members, for example, when the second electronic equipment is attached to the attachment portion.

### Aspect 12

Preferably, the first electronic equipment is an antenna unit including an antenna element. The second electronic equipment is a signal processing unit. The first electronic equipment is electrically connected to at least part of the wall-shaped member via the attachment portion.

According to aspect 12, when the first electronic equipment and the second electronic equipment are attached via the attachment portion, electrical connection (grounding) between the first electronic equipment and the wall-shaped member of the vehicle and electrical connection between the first electronic equipment and the second electronic equipment can also be performed.

### Aspect 13

Electronic equipment of a device for vehicle includes a connector, a substrate on which the connector is mounted, and a chassis having a connector arranged region through which part of the connector passes. The connector is used to electrically connect with another electronic equipment of the device for vehicle. A method for assembling electronic equipment includes: a step of causing the connector mounted on the substrate to pass through the connector arranged region, and a fixing step of fixing to the chassis, the substrate in a state in which a positional relationship between the substrate or the connector and the chassis varies according to a positional relationship between the connector and the substrate.

### Aspect 14

The device for vehicle includes first electronic equipment, second electronic equipment, and an attachment portion. The first electronic equipment includes a first connector, a first substrate on which the first connector is mounted, and a first chassis. The first substrate is fixed to the first chassis in a state where a positional relationship between the first substrate or the first connector and the first chassis varies according to a positional relationship between the first connector and the first substrate. The second electronic equipment includes a second connector, a second substrate on which the second connector is mounted, and a second chassis. The second substrate is fixed to the second chassis in a state where a positional relationship between the second substrate or the second connector and the second chassis varies according to a positional relationship between the second connector and the second substrate. The first electronic equipment and the second electronic equipment are electrically connected via the first connector and the second connector. A method for attaching a device for vehicle includes: a first step of temporarily fixing the first electronic equipment to a wall-shaped member of a vehicle; a second step of attaching the first electronic equipment to the vehicle in a positional relationship in which the first electronic equipment and an attachment portion sandwich at least part of the wall-shaped member; and a third step of attaching second electronic equipment to the attachment portion in a positional relationship in which the second electronic equipment and the wall-shaped member sandwich at least part of the attachment portion.

### Aspect 15

Preferably, in the third step, the second electronic equipment is fixed to the attachment portion in a state where a positional relationship between the attachment portion and the second electronic equipment varies according to at least one of a positional relationship between the first connector and the attachment portion and a positional relationship between the first connector and the second electronic equipment.

### Aspect 16

Electronic equipment of a device for vehicle includes a connector, a substrate on which the connector is mounted, and a chassis having a connector arranged region through which part of the connector passes. The connector is used to electrically connect with another electronic equipment of the device for vehicle. A method for assembling electronic equipment executes a fixing step of fixing to the chassis, the substrate in a state in which a positional relationship between the substrate or the connector and the chassis varies according to a positional relationship between the connector and the substrate.

### REFERENCE SIGNS LIST

1 Device for vehicle (antenna device for vehicle)
10 First electronic equipment (antenna unit)
11 Antenna case
13 Pad
15 Antenna element
17 First substrate
18a First substrate-side attachment portion
18a1 11th long hole
18a2 12th long hole
18a3 13th long hole
19 Base
19a First connector arranged region
19b Connector cover portion
19c Base-side fastening portion hole
19d Wall portion
20 Base-side attachment portion
21 First connector
30 Attachment portion
31 Contact portion (claw washer)
31a First flat portion
31b Claw portion
33 Body portion (bracket)
33a Second flat portion
33a1 Attachment portion-side connector arranged region
33b Leg portion
35 First arm portion
35a First arm portion-side attachment portion
37 First fastening portion (bolt)
50 Second electronic equipment (signal processing unit)
51 Lid portion
51a1 Connector guide portion
51a2 Upper surface recess portion
51a3 Second connector arranged region
51b First storage groove
51c Lid portion-side attachment portion
52 Bottom portion
2b Second storage groove
53 Second substrate
54a Second substrate-side attachment portion
54a1 21st long hole
54a2 22nd long hole
54a3 23rd long hole
55 Second arm portion
55a Second arm portion-side attachment portion
57 Second fastening portion
61 Second connector
90 Vehicle roof
91 Vehicle attachment hole
d Distance between two leg portions facing each other in y direction
d1 First distance (width in y direction of lid portion and bottom portion)
d2 Second distance (distance between two first storage grooves facing each other in y direction)
LX1 Center line of first substrate in y direction as viewed from z direction
LX2 Center line of second substrate in y direction as viewed from z direction
LX3 Center line of second electronic equipment 50 in y direction as viewed from z direction
w Width of leg portion in x direction
w1 Width of first storage groove in x direction

1. Electronic equipment of a device for vehicle, comprising:
a connector for electrically connecting with another electronic equipment of the device for vehicle;
a substrate on which the connector is mounted; and
a chassis,
wherein the substrate is fixed to the chassis in a state in which a positional relationship between the substrate or the connector and the chassis varies according to a positional relationship between the connector and the substrate.

2. The electronic equipment according to claim 1,
wherein the substrate is fixed to the chassis by screwing, and
at least one of the substrate and the chassis is provided with a hole or a notch in a region to be used for the screwing.

3. The electronic equipment according to claim 2, wherein the hole is a long hole or a clearance hole.

4. The electronic equipment according to claim 2 ,
wherein the chassis has a connector arranged region through which part of the connector passes, and
a plurality of holes or notches provided in at least one of the substrate and the chassis and to be used for the screwing is provided such that the hole or the notch farther from at least one of the connector and the connector arranged region is larger than the hole or the notch closer from at least one of the connector and the connector arranged region.

5. A device for vehicle comprising:
first electronic equipment including a first connector, a first substrate on which the first connector is mounted, and a first chassis, the first substrate being fixed to the first chassis in a state where a positional relationship between the first substrate or the first connector and the first chassis varies according to a positional relationship between the first connector and the first substrate; and
second electronic equipment including a second connector, a second substrate on which the second connector is mounted, and a second chassis, the second substrate being fixed to the second chassis in a state where a positional relationship between the second substrate or the second connector and the second chassis varies according to a positional relationship between the second connector and the second substrate,
wherein the first electronic equipment and the second electronic equipment are electrically connected via the first connector and the second connector.

6. The device for vehicle according to claim 5, further comprising:
an attachment portion,
wherein the first electronic equipment is attached to the vehicle in a positional relationship in which the first electronic equipment and the attachment portion sandwich at least part of a wall-shaped member of the vehicle, and
the second electronic equipment is attached to the attachment portion in a positional relationship in which the second electronic equipment and the wall-shaped member sandwich at least part of the attachment portion.

7. The device for vehicle according to claim 6, wherein the second electronic equipment is fixed to the attachment portion in a state where a positional relationship between the attachment portion and the second electronic equipment varies according to a positional relationship between the first connector and the attachment portion and a positional relationship between the first connector and the second electronic equipment.

8. The device for vehicle according to claim 7,
wherein the wall-shaped member is a vehicle roof of the vehicle,
the attachment portion includes a body portion that covers part of the second electronic equipment in a positional relationship of not being in contact with the roof, a contact portion that is provided at a position closer to the roof than the body portion and is in contact with the roof, and a first arm portion,
the body portion includes a flat portion facing an upper surface of the second electronic equipment, and a leg portion extending downward from the flat portion and facing a side portion of the second electronic equipment,
a second arm portion is provided on a side portion of the second electronic equipment, and
the second electronic equipment is attached to the attachment portion via a fastening portion that penetrates the first arm portion and the second arm portion from below, and at least one of the first arm portion and the second arm portion is provided with a hole or a notch in a region to be used for attaching the attachment portion and the second electronic equipment.

9. The device for vehicle according to claim 8, wherein the hole provided in at least one of the first arm portion and the second arm portion is a long hole or a clearance hole.

10. The device for vehicle according to claim 8 ,
wherein the leg portion faces a storage groove provided in the side portion of the second electronic equipment, and
at least two leg portions as the leg portion are provided so as to sandwich a region including the storage groove of the second electronic equipment.

11. The device for vehicle according to claim 5
wherein a connector cover portion that covers a side surface of the first connector is provided in a region of the first chassis from which the first connector protrudes,
a connector guide portion that covers at least part of a side surface of the second connector and a recess portion into which the connector cover portion is to be inserted are provided in a region of the second chassis from which the second connector protrudes,
the second chassis has a connector arranged region through which part of the second connector passes, and
the connector arranged region is provided in the recess portion.

12. The device for vehicle according to claim 6
wherein the first electronic equipment is an antenna unit including an antenna element,
the second electronic equipment is a signal processing unit, and
the first electronic equipment is electrically connected to at least part of the wall-shaped member via the attachment portion.

13. A method for assembling electronic equipment of a device for vehicle, the electronic equipment comprising a connector, a substrate on which the connector is mounted, and a chassis having a connector arranged region through which part of the connector passes,
the connector being used to electrically connect with another electronic equipment of the device for vehicle, the method comprising:
a step of causing the connector mounted on the substrate to pass through the connector arranged region; and
a fixing step of fixing to the chassis, the substrate in a state in which a positional relationship between the substrate or the connector and the chassis varies according to a positional relationship between the connector and the substrate.

14. A method for attaching a device for vehicle including first electronic equipment, second electronic equipment, and an attachment portion,
the first electronic equipment including a first connector, a first substrate on which the first connector is mounted, and a first chassis, and the first substrate being fixed to the first chassis in a state where a positional relationship between the first substrate or the first connector and the first chassis varies according to a positional relationship between the first connector and the first substrate,
the second electronic equipment including a second connector, a second substrate on which the second connector is mounted, and a second chassis, the second substrate being fixed to the second chassis in a state where a positional relationship between the second substrate or the second connector and the second chassis varies according to a positional relationship between the second connector and the second substrate, and
the first electronic equipment and the second electronic equipment being electrically connected via the first connector and the second connector, the method comprising:
a first step of temporarily fixing the first electronic equipment to a wall-shaped member of a vehicle;
a second step of attaching the first electronic equipment to the vehicle in a positional relationship in which the first electronic equipment and the attachment portion sandwich at least part of the wall-shaped member; and
a third step of attaching the second electronic equipment to the attachment portion in a positional relationship in which the second electronic equipment and the wall-shaped member sandwich at least part of the attachment portion.

15. The method for attaching the device for vehicle according to claim 14, wherein in the third step, the second electronic equipment is fixed to the attachment portion in a state where a positional relationship between the attachment portion and the second electronic equipment varies according to at least one of a positional relationship between the first connector and the attachment portion and a positional relationship between the first connector and the second electronic equipment.

16. A method for assembling electronic equipment of a device for vehicle, the electronic equipment including a connector, a substrate on which the connector is mounted, and a chassis having a connector arranged region through which part of the connector passes,
the connector being used to electrically connect with another electronic equipment of the device for vehicle, the method comprising:
a fixing step of fixing to the chassis, the substrate in a state in which a positional relationship between the substrate or the connector and the chassis varies according to a positional relationship between the connector and the substrate.
